(19) United States
(12) Patent Application Publication
(10) Pub. No.: US 2024/0250780 A1
(43) Pub. Date: Jul. 25, 2024

(54) FEEDBACK SIGNALING IN CARRIER AGGREGATION AND OUTER CODING SCENARIOS

(71) Applicant: QUALCOMM Incorporated, San Diego, CA (US)

(72) Inventors: Amira Alloum, Boulogne Billancourt (FR); Mickael Mondet, Louannec (FR); Peerapol Tinnakornsrisuphap, San Diego, CA (US); Ravi Agarwal, San Diego, CA (US); Yih-Hao Lin, San Diego, CA (US); Sanket Sanjay Kalamkar, San Diego, CA (US); Aziz Gholmieh, Del Mar, CA (US); Jing Jiang, San Diego, CA (US)

(21) Appl. No.: 18/157,769

(22) Filed: Jan. 20, 2023

(51) Int. Cl. H04L 1/1829; H04L 5/00; H04W 72/20

(52) U.S. Cl. CPC H04L 1/1854; H04L 5/0053; H04W 72/20; H04L 1/1812

(57) ABSTRACT

Methods, systems, and devices for wireless communications are described. A UE may receive outer coded downlink signaling via carrier aggregation, and may deactivate retransmission protocols and then selecting at least one of two different feedback modes. A first feedback mode may include a radio link control (RLC) status report mode (e.g., which may be referred to as mode 1, or RLC mode 1). A second feedback mode is a hybrid automatic repeat request (HARQ) feedback mode (e.g., which may be referred to as mode 2, or HARQ mode 2. The network may configure the UE with parameters for operating in mode 1, mode 2, or both, or the UE may select a feedback mode autonomously. The UE may refrain from transmitting additional feedback signaling, and retransmissions may be deactivated, resulting in improved power savings and more efficient use of system resources.

### FIELD OF TECHNOLOGY

The following relates to wireless communications, including feedback signaling in carrier aggregation and outer coding scenarios.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support feedback signaling in carrier aggregation and outer coding scenarios. For example, the described techniques support deactivating retransmission protocols when outer coding is used (e.g., in multicast use cases), as well as for use of alternative feedback solutions when retransmission has been deactivated. A user equipment (UE) receiving outer coded downlink signaling via carrier aggregation may deactivate retransmission protocols and then select at least one of two different feedback modes. A first feedback mode may include a radio link control (RLC) status report mode (e.g., which may be referred to as mode 1, or RLC mode 1). A second feedback mode is a hybrid automatic repeat request (HARQ) feedback mode (e.g., which may be referred to as mode 2, or HARQ mode 2). Both modes may also be used in combination. The network may configure the UE with parameters for operating in mode 1, mode 2, or both. In some examples, the network may indicate which mode the UE is to use upon deactivation of the retransmission protocols due to the use of outer coding. In some examples, the UE may select a feedback mode based on one or more conditions being satisfied, including when retransmission is deactivated. Regardless of the feedback mode used, the feedback signaling may result in updates to the outer coding used (e.g., may not result in retransmission). The UE may refrain from transmitting additional feedback signaling, and retransmissions may be deactivated, resulting in improved power savings and more efficient use of system resources.

A method for wireless communications at a UE is described. The method may include receiving, via carrier aggregation, one or more downlink messages from a network entity in accordance with an outer coding transmission scheme, deactivating a retransmission protocol associated with the one or more downlink messages based on the outer coding transmission scheme being applied to the one or more downlink messages, selecting, based on the outer coding transmission scheme being applied to the one or more downlink messages, at least one of a first feedback mode associated with RLC reporting and a first set of resources or a second feedback mode associated with hybrid-automatic request reporting and a second set of resources, and transmitting a feedback message corresponding to the one or more downlink messages via the first set of resources or the second set of resources according to the selected feedback mode.

An apparatus for wireless communications at a UE is described. The apparatus may include a processor, memory coupled with the processor, and instructions stored in the memory. The instructions may be executable by the processor to cause the apparatus to receive, via carrier aggregation, one or more downlink messages from a network entity in accordance with an outer coding transmission scheme, deactivate a retransmission protocol associated with the one or more downlink messages based on the outer coding transmission scheme being applied to the one or more downlink messages, select, based on the outer coding transmission scheme being applied to the one or more downlink messages, at least one of a first feedback mode associated with RLC reporting and a first set of resources or a second feedback mode associated with hybrid-automatic request reporting and a second set of resources, and transmit a feedback message corresponding to the one or more downlink messages via the first set of resources or the second set of resources according to the selected feedback mode.

Another apparatus for wireless communications at a UE is described. The apparatus may include means for receiving, via carrier aggregation, one or more downlink messages from a network entity in accordance with an outer coding transmission scheme, means for deactivating a retransmission protocol associated with the one or more downlink messages based on the outer coding transmission scheme being applied to the one or more downlink messages, means for selecting, based on the outer coding transmission scheme being applied to the one or more downlink messages, at least one of a first feedback mode associated with RLC reporting and a first set of resources or a second feedback mode associated with hybrid-automatic request reporting and a second set of resources, and means for transmitting a feedback message corresponding to the one or more downlink messages via the first set of resources or the second set of resources according to the selected feedback mode.

A non-transitory computer-readable medium storing code for wireless communications at a UE is described. The code may include instructions executable by a processor to receive, via carrier aggregation, one or more downlink messages from a network entity in accordance with an outer coding transmission scheme, deactivate a retransmission protocol associated with the one or more downlink messages based on the outer coding transmission scheme being applied to the one or more downlink messages, select, based on the outer coding transmission scheme being applied to the one or more downlink messages, at least one of a first feedback mode associated with RLC reporting and a first set of resources or a second feedback mode associated with hybrid-automatic request reporting and a second set of resources, and transmit a feedback message corresponding to the one or more downlink messages via the first set of resources or the second set of resources according to the selected feedback mode.

Some examples of the method, apparatuses, and non-transitory computer-readable medium described herein may further include operations, features, means, or instructions for receiving, from the network entity, control signaling indicating one or more parameters for use of the first feedback mode, the second feedback mode, or both, where the selecting may be based on the one or more parameters.

Some examples of the method, apparatuses, and non-transitory computer-readable medium described herein may further include operations, features, means, or instructions for selecting the at least one of the first feedback mode or the second feedback mode based on one or more conditions being satisfied, where the one or more conditions may be associated with a power status at the UE, a threshold latency corresponding to the one or more downlink messages, or a combination thereof.

In some examples of the method, apparatuses, and non-transitory computer-readable medium described herein, the selecting may include operations, features, means, or instructions for selecting a combination of the first feedback mode and the second feedback mode, where the first feedback mode corresponds to a first periodicity and the second feedback mode corresponds to a second periodicity, where the first periodicity may be greater than the second periodicity.

In some examples of the method, apparatuses, and non-transitory computer-readable medium described herein, transmitting the feedback message may include operations, features, means, or instructions for transmitting a first feedback message via the first set of resources according to the first periodicity and transmitting a second feedback message via the second set of resources according to the second periodicity.

In some examples of the method, apparatuses, and non-transitory computer-readable medium described herein, transmitting the feedback message may include operations, features, means, or instructions for activating a first resource of the second set of resources according to the second periodicity and transmitting, via the activated first resource of the second set of resources, a block error report, an indication of a missed message via a physical downlink control channel, or a combination thereof.

In some examples of the method, apparatuses, and non-transitory computer-readable medium described herein, transmitting the first feedback message and the second feedback message may include operations, features, means, or instructions for alternating between transmitting via respective resources associated with the first set of resources and the second set of resources according to the first periodicity and the second periodicity.

In some examples of the method, apparatuses, and non-transitory computer-readable medium described herein, transmitting the feedback message may include operations, features, means, or instructions for transmitting a RLC status report via the first set of resources according to the first feedback mode based on detecting a missed RLC packet data unit, where a HARQ protocol associated with the second feedback mode may be deactivated according to the selecting.

Some examples of the method, apparatuses, and non-transitory computer-readable medium described herein may further include operations, features, means, or instructions for allowing one or more timers to expire, or setting the one or more timers to zero, based on selecting the first feedback mode, where the one or more timers may be associated with RLC status signaling.

Some examples of the method, apparatuses, and non-transitory computer-readable medium described herein may further include operations, features, means, or instructions for including, in the RLC status report, an indication of a quantity of segments associated with the outer coding transmission scheme that may have been successfully received by the UE.

In some examples of the method, apparatuses, and non-transitory computer-readable medium described herein, transmitting the feedback message may include operations, features, means, or instructions for transmitting a set of multiple feedback messages via the first set of resources of a primary component carrier for a first cell group and via the second set of resources of the primary component carrier for the first cell group, the set of multiple feedback messages including the feedback message.

Some examples of the method, apparatuses, and non-transitory computer-readable medium described herein may further include operations, features, means, or instructions for generating the feedback message according to a HARQ codebook type, where transmitting the feedback message may be based on the generating.

Some examples of the method, apparatuses, and non-transitory computer-readable medium described herein may further include operations, features, means, or instructions for entering a sleep mode based on transmitting the feedback message and deactivating the carrier aggregation, the outer coding transmission scheme, or both, based on entering the sleep mode.

Some examples of the method, apparatuses, and non-transitory computer-readable medium described herein may further include operations, features, means, or instructions for refraining from transmitting one or more additional feedback messages via at least a portion of the first set of resources and the second set of resources associated with retransmissions of the one or more downlink messages based on entering the sleep mode during the portion of the first set of resources and the second set of resources, deactivating the retransmission protocol, or both.

Some examples of the method, apparatuses, and non-transitory computer-readable medium described herein may further include operations, features, means, or instructions for receiving, from the network entity based on transmitting the feedback message, an indication that no additional downlink messages may be pending, where entering the sleep mode may be based on receiving the indication.

Some examples of the method, apparatuses, and non-transitory computer-readable medium described herein may further include operations, features, means, or instructions for receiving, from the network entity, an indication of a threshold quantity of segments associated with the outer coding transmission scheme, where entering the sleep mode may be based on the quantity of segments associated with the outer coding transmission scheme that may have been successfully received by the UE satisfies the threshold quantity of segments.

Some examples of the method, apparatuses, and non-transitory computer-readable medium described herein may further include operations, features, means, or instructions for receiving, from the network entity, an indication of a periodicity associated with the first feedback mode, the second feedback mode, or a combination thereof, where transmitting the feedback message may be based on the periodicity.

Some examples of the method, apparatuses, and non-transitory computer-readable medium described herein may further include operations, features, means, or instructions for receiving control signaling triggering aperiodic feedback signaling via the first set of resources or the second set of resources, where transmitting the feedback message may be based on receiving the control signaling.

Some examples of the method, apparatuses, and non-transitory computer-readable medium described herein may further include operations, features, means, or instructions for receiving control signaling indicating a carrier aggregation mode, an instruction to deactivate RLC retransmissions, or a combination thereof.

In some examples of the method, apparatuses, and non-transitory computer-readable medium described herein, the outer coding transmission scheme includes a packet data convergence protocol (PDCP) distribution outer coding scheme associated with a threshold link quality.

A method for wireless communications at a network entity is described. The method may include generating one or more downlink messages according to an outer coding transmission scheme, transmitting the one or more downlink messages to a UE via carrier aggregation in accordance with the outer coding transmission scheme, selecting, based on generating the one or more downlink messages according to the outer coding transmission scheme, at least one of a first feedback mode associated with RLC reporting and a first set of resources or a second feedback mode associated with hybrid-automatic request reporting and a second set of resources, and receiving a feedback message corresponding to the one or more downlink messages via the first set of resources or the second set of resources according to the selected feedback mode.

An apparatus for wireless communications at a network entity is described. The apparatus may include a processor, memory coupled with the processor, and instructions stored in the memory. The instructions may be executable by the processor to cause the apparatus to generate one or more downlink messages according to an outer coding transmission scheme, transmit the one or more downlink messages to a UE via carrier aggregation in accordance with the outer coding transmission scheme, select, based on generating the one or more downlink messages according to the outer coding transmission scheme, at least one of a first feedback mode associated with RLC reporting and a first set of resources or a second feedback mode associated with hybrid-automatic request reporting and a second set of resources, and receive a feedback message corresponding to the one or more downlink messages via the first set of resources or the second set of resources according to the selected feedback mode.

Another apparatus for wireless communications at a network entity is described. The apparatus may include means for generating one or more downlink messages according to an outer coding transmission scheme, means for transmitting the one or more downlink messages to a UE via carrier aggregation in accordance with the outer coding transmission scheme, means for selecting, based on generating the one or more downlink messages according to the outer coding transmission scheme, at least one of a first feedback mode associated with RLC reporting and a first set of resources or a second feedback mode associated with hybrid-automatic request reporting and a second set of resources, and means for receiving a feedback message corresponding to the one or more downlink messages via the first set of resources or the second set of resources according to the selected feedback mode.

A non-transitory computer-readable medium storing code for wireless communications at a network entity is described. The code may include instructions executable by a processor to generate one or more downlink messages according to an outer coding transmission scheme, transmit the one or more downlink messages to a UE via carrier aggregation in accordance with the outer coding transmission scheme, select, based on generating the one or more downlink messages according to the outer coding transmission scheme, at least one of a first feedback mode associated with RLC reporting and a first set of resources or a second feedback mode associated with hybrid-automatic request reporting and a second set of resources, and receive a feedback message corresponding to the one or more downlink messages via the first set of resources or the second set of resources according to the selected feedback mode.

Some examples of the method, apparatuses, and non-transitory computer-readable medium described herein may further include operations, features, means, or instructions for transmitting, to the UE, control signaling indicating one or more parameters for use of the first feedback mode, the second feedback mode, or both, where the selecting may be based on the one or more parameters.

Some examples of the method, apparatuses, and non-transitory computer-readable medium described herein may further include operations, features, means, or instructions for selecting the at least one of the first feedback mode and the second feedback mode based on one or more conditions being satisfied, where the one or more conditions may be associated with a power status at the UE, a threshold latency corresponding to the one or more downlink messages, or a combination thereof.

In some examples of the method, apparatuses, and non-transitory computer-readable medium described herein, the selecting may include operations, features, means, or instructions for selecting a combination of the first feedback mode and the second feedback mode, where the first feedback mode corresponds to a first periodicity and the second feedback mode corresponds to a second periodicity, where the first periodicity may be greater than the second periodicity.

In some examples of the method, apparatuses, and non-transitory computer-readable medium described herein, receiving the feedback message may include operations, features, means, or instructions for receiving a first feedback message via the first set of resources according to the first periodicity and receiving a second feedback message via the second set of resources according to the second periodicity.

In some examples of the method, apparatuses, and non-transitory computer-readable medium described herein, receiving the first feedback message and the second feedback message may include operations, features, means, or instructions for alternating between receiving via respective resources associated with the first set of resources and the second set of resources according to the first periodicity and the second periodicity.

In some examples of the method, apparatuses, and non-transitory computer-readable medium described herein, receiving the feedback message may include operations, features, means, or instructions for receiving a RLC status report via the first set of resources according to the first feedback mode indicating a missed RLC packet data unit, where a HARQ protocol associated with the second feedback mode may be deactivated according to the selecting.

Some examples of the method, apparatuses, and non-transitory computer-readable medium described herein may further include operations, features, means, or instructions for receiving, in the RLC status report, an indication of a quantity of segments associated with the outer coding transmission scheme that may have been successfully received by the UE.

Some examples of the method, apparatuses, and non-transitory computer-readable medium described herein may further include operations, features, means, or instructions for transmitting, to the UE, an indication of a threshold quantity of segments associated with the outer coding transmission scheme and refraining from transmitting one or more additional segments associated with the outer coding transmission scheme based on the quantity of segments associated with the outer coding transmission scheme satisfying the threshold quantity of segments.

In some examples of the method, apparatuses, and non-transitory computer-readable medium described herein, receiving the feedback message may include operations, features, means, or instructions for receiving a set of multiple feedback messages via the first set of resources of a primary component carrier for a first cell group and via the second set of resources of the primary component carrier for the first cell group, the set of multiple feedback messages including the feedback message.

In some examples of the method, apparatuses, and non-transitory computer-readable medium described herein, receiving the feedback message may include operations, features, means, or instructions for receiving the feedback message according to a HARQ codebook type.

Some examples of the method, apparatuses, and non-transitory computer-readable medium described herein may further include operations, features, means, or instructions for refraining from transmitting one or more additional downlink messages based on receiving the feedback message and refraining from monitoring for one or more additional feedback messages during at least a portion of the first set of resources, the second set of resources, or both.

Some examples of the method, apparatuses, and non-transitory computer-readable medium described herein may further include operations, features, means, or instructions for deactivating a retransmission protocol associated with the one or more downlink messages, where refraining from transmitting the one or more additional downlink messages may be based on the deactivating.

Some examples of the method, apparatuses, and non-transitory computer-readable medium described herein may further include operations, features, means, or instructions for transmitting, to the UE, an indication that the one or more additional downlink messages may be not pending, where refraining from transmitting the one or more additional downlink messages may be based on receiving the indication.

Some examples of the method, apparatuses, and non-transitory computer-readable medium described herein may further include operations, features, means, or instructions for transmitting, to the UE, an indication of a periodicity associated with the first feedback mode, the second feedback mode, or a combination thereof, where receiving the feedback message may be based on the periodicity.

Some examples of the method, apparatuses, and non-transitory computer-readable medium described herein may further include operations, features, means, or instructions for transmitting control signaling triggering aperiodic feedback signaling via the first set of resources or the second set of resources, where receiving the feedback message may be based on receiving the control signaling.

Some examples of the method, apparatuses, and non-transitory computer-readable medium described herein may further include operations, features, means, or instructions for transmitting control signaling indicating a carrier aggregation mode, an instruction to deactivate RLC retransmissions, or a combination thereof.

In some examples of the method, apparatuses, and non-transitory computer-readable medium described herein, the outer coding transmission scheme includes a PDCP distribution outer coding scheme associated with a threshold link quality.

### BRIEF DESCRIPTION OF THE DRAWINGS

FIG. 1 illustrates an example of a wireless communications system that supports feedback signaling in carrier aggregation and outer coding scenarios in accordance with one or more aspects of the present disclosure.

FIG. 2 illustrates an example of a wireless communications system that supports feedback signaling in carrier aggregation and outer coding scenarios in accordance with one or more aspects of the present disclosure.

FIG. 3 illustrates an example of a timeline that supports feedback signaling in carrier aggregation and outer coding scenarios in accordance with one or more aspects of the present disclosure.

FIG. 4 illustrates an example of a timeline that supports feedback signaling in carrier aggregation and outer coding scenarios in accordance with one or more aspects of the present disclosure.

FIG. 5 illustrates an example of a process flow that supports feedback signaling in carrier aggregation and outer coding scenarios in accordance with one or more aspects of the present disclosure.

FIGS. 6 and 7 illustrate block diagrams of devices that support feedback signaling in carrier aggregation and outer coding scenarios in accordance with one or more aspects of the present disclosure.

FIG. 8 illustrates a block diagram of a communications manager that supports feedback signaling in carrier aggregation and outer coding scenarios in accordance with one or more aspects of the present disclosure.

FIG. 9 illustrates a diagram of a system including a device that supports feedback signaling in carrier aggregation and outer coding scenarios in accordance with one or more aspects of the present disclosure.

FIGS. 10 and 11 illustrate block diagrams of devices that support feedback signaling in carrier aggregation and outer coding scenarios in accordance with one or more aspects of the present disclosure.

FIG. 12 illustrates a block diagram of a communications manager that supports feedback signaling in carrier aggregation and outer coding scenarios in accordance with one or more aspects of the present disclosure.

FIG. 13 illustrates a diagram of a system including a device that supports feedback signaling in carrier aggregation and outer coding scenarios in accordance with one or more aspects of the present disclosure.

FIGS. 14 through 17 illustrate flowcharts showing methods that support feedback signaling in carrier aggregation and outer coding scenarios in accordance with one or more aspects of the present disclosure.

### DETAILED DESCRIPTION

Some wireless communications (e.g., extended reality (XR) traffic) may rely on stringent latency thresholds, high throughput, and specific reliability requirements. In such communications, a wireless communications system may support procedures that provide robustness of communications. One such action may include the use of packet data convergence protocol (PDCP) duplication, which may include the transmission of duplicated packets. Additional options for supporting robust communications may include outer coding. In an outer coding scenario, some redundancy in packet transmission may be permitted, but a receiving device may successfully decode a received transmission even if fewer than all transmitted packets are received. Outer coding may leverage link diversity and enhance reliability, and may further support successful transmissions (e.g., video frame deliveries) without relying on retransmission protocols. However, a user equipment (UE) may expend increased power in repetitive feedback signaling (e.g., despite the improved reliability of outer coding). Feedback signaling may also unnecessarily utilize available system resources. Retransmission protocols may also result in increased system latency and decreased spectral efficiency.

Techniques described herein provide rules for deactivating retransmission protocols when outer coding is used (e.g., in multicast use cases), as well as for use of alternative feedback solutions when retransmission has been deactivated. The techniques described herein may result in an increase in power savings and spectral efficiency by generally reducing feedback signaling overhead. A UE receiving outer coding downlink signaling may implement the new power saving rules by deactivating retransmission protocols and then selecting at least one of two different feedback modes. A first feedback mode may include a radio link control (RLC) report mode (e.g., which may be referred to as mode 1, or RLC mode 1). A second feedback mode is a hybrid automatic repeat request (HARQ) feedback mode (e.g., which may be referred to as mode 2, or HARQ mode 2). Both modes may also be used in combination. The network may configure the UE with parameters for operating in mode 1, mode 2, or both. In some examples, the network may indicate which mode the UE is to use upon deactivation of the retransmission protocols due to the use of outer coding. In some examples, the UE may select a feedback mode based on one or more conditions being satisfied, including when retransmission is deactivated. Regardless of the feedback mode used, the feedback signaling may result in updates to the outer coding used (e.g., may not result in retransmission).

Aspects of the disclosure are initially described in the context of wireless communications systems. Aspects of the disclosure are further illustrated by and described with reference to wireless communications systems, timelines, and process flows. Aspects of the disclosure are further illustrated by and described with reference to apparatus diagrams, system diagrams, and flowcharts that relate to feedback signaling in carrier aggregation and outer coding scenarios.

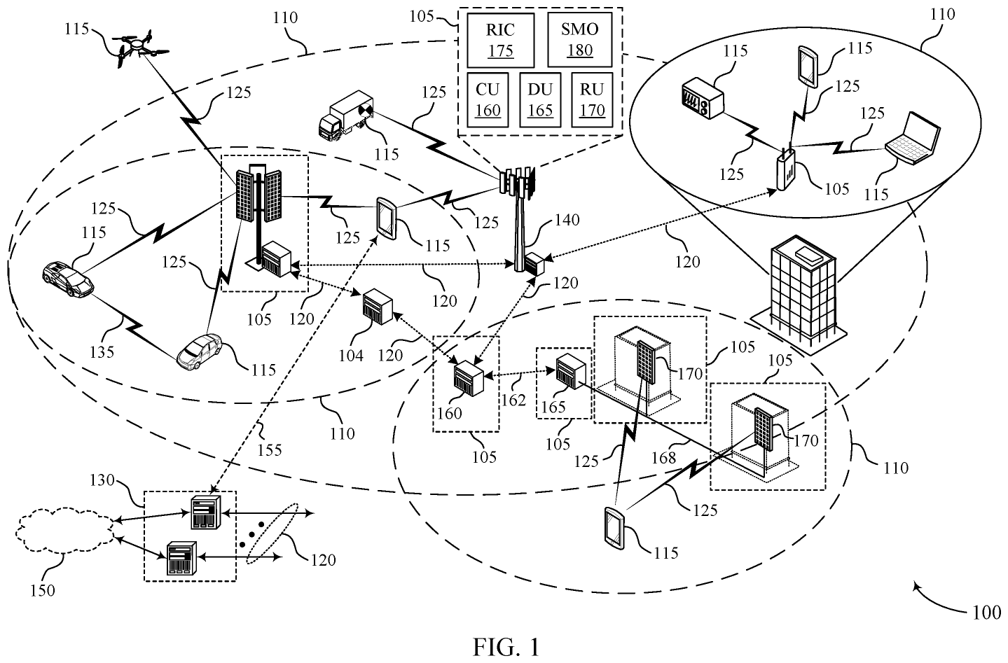

FIG. 1 illustrates an example of a wireless communications system 100 that supports feedback signaling in carrier aggregation and outer coding scenarios in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1. In some examples, UEs may be examples of apparatuses.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., RLC layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support feedback signaling in carrier aggregation and outer coding scenarios as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may for example, refer to a sampling period of Tₛ=1/(Δƒₘₐₓ19 N_{ƒ}) seconds, for which ƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Described techniques may support deactivating retransmission protocols when outer coding is used (e.g., in multicast use cases), as well as for use of alternative feedback solutions when retransmission has been deactivated. A UE 115 may receive outer coded downlink signaling via carrier aggregation and may deactivate retransmission protocols and then select at least one of two different feedback modes. A first feedback mode may include a RLC status report mode (e.g., which may be referred to as mode 1, or RLC mode 1). A second feedback mode is a HARQ feedback mode (e.g., which may be referred to as mode 2, or HARQ mode 2). Both modes may also be used in combination. The network may configure the UE with parameters for operating in mode 1, mode 2, or both. In some examples, the network may indicate which mode the UE 115 is to use upon deactivation of the retransmission protocols due to the use of outer coding. In some examples, the UE may select a feedback mode based on one or more conditions being satisfied, including when retransmission is deactivated. Regardless of the feedback mode used, the feedback signaling may result in updates to the outer coding used (e.g., may not result in retransmission). The UE 115 may refrain from transmitting additional feedback signaling, and retransmissions may be deactivated, resulting in improved power savings and more efficient use of system resources.

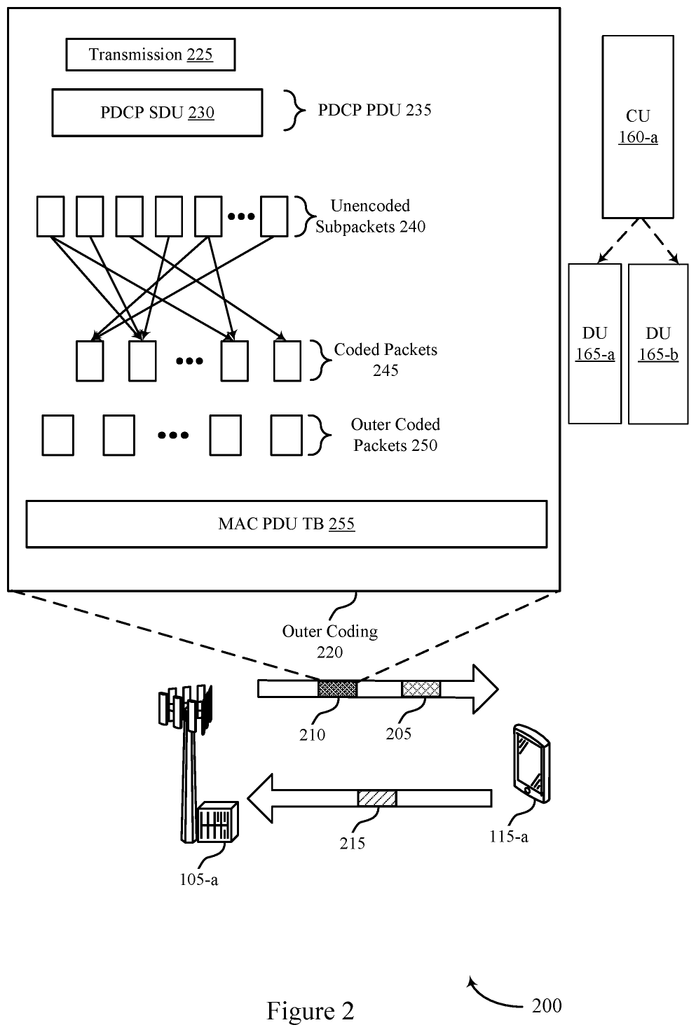

FIG. 2 illustrates an example of a wireless communications system 200 that supports feedback signaling in carrier aggregation and outer coding scenarios in accordance with one or more aspects of the present disclosure. Wireless communications system 200 may implement aspects of, or may be implemented by aspects of, the wireless communications system 100. For example, the wireless communications system 200 may include a network entity 105-a and a UE 115-a, which may be examples of corresponding devices described with reference to FIG. 1.

The network entity 105-a may transit, to the UE 115-a, downlink signaling 210. In some examples, the downlink signaling may be configured by control signaling 205. The UE 115-a may transmit feedback message 215 indicating successful (e.g., or unsuccessful) reception of the downlink signaling 210. In some examples, the downlink signaling 210 may be an example of low latency signaling, such as extra reality (XR) traffic, which may rely on stringent latency constraints, higher throughput, and critical reliability with low UE power consumption. In some examples, the network entity 105-a nay perform outer coding 220 on the downlink signaling 210, which may include, for example, PDCP duplication to leverage link diversity and enhance reliability of wireless signaling with reduced delays (e.g., compared to exclusive use of HARQ retransmission and RLC layer retransmissions).

Upper layer outer coding 220 may support successful video frame delivery without relying on such retransmission protocols. outer layer coding may therefore be considered an alternative to retransmission protocols, while improving latency reduction, and power saving techniques (e.g., in a unicast context). Outer coding may enhance upper layer dynamic adaptation by leveraging link diversity, and may enhance resource and spectral efficiency. PDCP duplication may be limited by repetition codes and one hundred percent redundancy. Outer coding 220 may involve an incremental redundancy, with more efficiency transmissions (e.g., traffic or channel specific adaptation). PDCP duplication may be a trivial case of outer coding 220. In some cases, outer coding 220 may be referred to as PDCP duplication or PDCP split outer coding.

In some examples (e.g., instead of relying on outer coding), a wireless communications system may support feedback signaling, retransmission protocols, etc., to increase reliability of signaling. However, outer coding procedures may increase the reliability of signaling, even in cases where portions of a transmission are not received by the receiving device. Thus, a transmitting device and receiving device may unnecessarily expend power, utilize system resources, and increase system latency by implementing retransmission protocols, excessive feedback signaling, etc. (e.g., despite the increased reliability of outer coding).

The network entity 105-a may support outer coding 220, which may occur at the PDCP level at the CU (e.g., of the network entity 105-a). For example, for a transmission 225, the network entity 105-a may segment a PDCP (e.g., which includes a PDCP SDU 230 and a header) into a quantity K of source packets (e.g., unencoded subpackets 240) of equal size. The code rate may be configured based on a worst-case scenario, or a rateless code. In some examples, no split may occur at the PDCP level, if one DU (e.g., DU 165-a) is involved. If there are multiple DUs 165 (e.g., DU 165-a and DU 165-b), then the outer coding may replace PDCP duplication, and may split different groups of outer coded packets 250 over the multiple DU legs (e.g., via different component carriers). For example, the unencoded subpackets 240 may be encoded into a quantity N of coded packets 245 at the network coding sublayer of the network entity 105-a. The coded packets 245 may be outer coded into outer coded packets 250 at an RLC layer of the network entity 105-a, and the outer coded packets 250 may be included in one or more MAC protocol data unit (PDU) TBs 265. The CU (e.g., managing the PDCP PDU 235 at the PDCP layer and the outer coding sublayer) may communicate with the DUs 165 (e.g., via F1-U interfaces). The CU 160-a may provide the segments (e.g., the outer coded packets 250) to the DUs 165. The DU 165-aand the DU 165-b, for example, may receive the segments encapsulated in the RLC SDU 230, with a size that may be fixed by the MAC layer, after calculation of the TB 255. After encapsulation of the header, the DUs 165 may obtain the RLC PDU of size dimensioned by the MAC layer. The MAC layer may reassemble the required RLC PDU number and may encapsulate the header to build the MAC PDU TB 255. The MAP PDU may be split over multiple CCs (e.g., in a CA mode). For example, the DU 165-a may transmit a first set of outer coded segments via a first leg (e.g., a first set of one or more CCs) and the DU 165-b may transmit a second set of outer coded segments via a second leg (e.g., a second set of one or more CCs).

The UE 115-a may receive the downlink signaling 210 (e.g., via the DU 165-a, the DU 165-b, or both), and may perform techniques described herein to provide the feedback message 215 to conserve power and reduce signaling overhead. For example, RLC and HARQ retransmission protocols may be deactivated, but the UE 115-a may use feedback mechanisms for RLC or HARQ protocols to convey feedback signaling. In some examples, PDCP in order delivery may also be disabled. The UE 115-a may use RLC-AM mode for RLC status reporting activated by enforcing one or more timers (e.g., a t_Reassembly timer set to 0), or by ignoring one or more timers (e.g., by ignoring t-Reassembly and t_Prohibit, which may be the names of timers associated with feedback signaling).

Techniques described herein include feedback reduction protocols for outer coding (e.g., PDCP split outer coding, among other examples). Such techniques may be implemented, for example, in a carrier aggregation use case, and may result in power savings. Techniques may also exclude other retransmission protocols (e.g., HARQ or RLC protocols).

Techniques described herein may increase power savings and spectral efficiency by feedback reduction. For example, outer coding may involve generating redundancy at the transmitter side. In the context of carrier aggregation, some feedback reduction techniques may concentrate on acknowledgement (ACK) signaling over a primary component carrier. However, if ACK signaling associated with HARQ feedback signaling are all transmitted, such signaling may overload the use of control channel (e.g., PUCCH resources), and may compromise the power consumption of the device (e.g., the UE). Techniques described herein may reduce power and resource consumption by deactivating at least some HARQ or RLC retransmissions, and reducing feedback by limiting the pace of ACK signaling (e.g., by alternating and combining HARQ ACK feedback with RLC status feedback signaling, as described herein).

Techniques described herein may also increase power saving and spectral efficiency, while decreasing latency by deactivating retransmission protocols. For example, in a unicast use case (e.g., without carrier aggregation or PDCP duplication), HARQ mechanisms and RLC mechanisms, and related feedback signaling (e.g., ACK signaling) involve high power consumption. In addition, retransmission protocols may degrade the reliability or may otherwise fail to support low latency use cases (e.g., XR cases). Thus, by deactivating retransmission protocols, transmitting and receiving devices may refrain from retransmissions (e.g., in the case where a portion of a message is lost, but sufficient portions of the outer coded transmission have been received by the receiving device, and a retransmission becomes unnecessary), resulting in increased power savings, improved spectral efficiency, and decreased latency. Techniques described herein may also be compatible with various device types and generations. For example, new and legacy devices may support protocols described herein, and may be compatible with DU/CU split, among other evolutions and use cases (e.g., messages available via the F1-U interface). Techniques described herein may support a framework where outer coding operates at the DU of a device (e.g., between PDCP and RLC layers, among other examples). In some examples, a DU may be interoperable with a CU, and such interoperability may support discarding or exchanging of information between CU and DU outside of an F10U interface header.

As described herein, a receiving device (e.g., a UE) may disable a feedback mechanism (e.g., HARQ feedback and retransmission schemes), RLC mechanisms (e.g., RLC retransmission schemes), or both. For example, the UE may disable retransmission protocols (e.g., RLC and HARQ protocols) in any case where outer coding is enabled (e.g., if one or more conditions are satisfied, or if the network indicates to the UE that network encoding is currently being used or will be used for pending downlink communications). The UE may maintain feedback signaling (e.g., HARQ feedback signaling or RLC status feedback signaling, or both) according to one or more power saving rules (e.g., according to one or more feedback modes (e.g., RLC report mode 1, or HARQ report mode 2). If the UE selects feedback mode 1 (e.g., RLC report mode 1), the UE may transmit RLC status reports as feedback signaling (e.g., but not HARQ feedback signaling). If the UE selects the feedback mode 2 (e.g., the HARQ report mode 2), the UE may transmit feedback signaling via HARQ ACK/NACK feedback signaling. In some examples, mode 1 may be associated with a higher periodicity, while mode 2 may be used with a lower periodicity (e.g., may support some mechanisms such as HARQ block error report (BLER) control loops with the network entity, or detection of missed PDCCH signaling. For example, the UE may transmit feedback signaling via configured RLC status report messages at a high periodicity, and may occasionally (e.g., with a lower periodicity than the RLC stats report signaling) transmit a HARQ feedback message to support BLER signaling, or to indicated missed PDCCH signaling.

When operating according to mode 1, the UE may transmit RLC status feedback upon detecting a missed RLC PDU (e.g., instead of relying on a HARQ protocol to transmit feedback). In such examples, the UE may adjust or ignore one or more timers (e.g., or other parameters) to ensure immediate transmission of the RLC report. For example, the UE may enforce a first timer associated with transmission of the RLC PDU (e.g., a timer defined by a parameters such as t_Reassembly) to zero, or may use a timer (e.g., associated with a parameter such as StatusProhibit) to adjust the RLC status load. Or, in some examples, the UE may simply ignore both timers.

In some examples, the UE may transmit ACK/NACK signaling and RLC status feedback signaling. The UE may alternatively use the ACK/NACK signaling and the RLC status feedback signaling by transmitting the feedback signaling via a primary cell, or a primary carrier component, for each DU (e.g., for each cell group of a set of cell groups). Such signaling may be implemented by relying on a standardized algorithm. The RLC status feedback signaling may be activated more frequently than the HARQ feedback signaling (e.g., the RLC status feedback signaling may have a smaller periodicity and may therefore occur more often than the HARQ feedback signaling).

The UE (e.g., or any receiving device) may transmit the feedback signaling according to a HARQ codebook (e.g., a type 1 codebook or a type 2 codebook). In some examples, the feedback signaling may be simplified. For example, the UE operating according to mode 1 may transmit the RLC status report (e.g., instead of a NACK message) if a time window, a codebook size, or both, make it possible to totally discard the use of HARQ Ack/NACK signaling. In such examples, the UE may transmit RLC status reports, and may refrain from transmitting any HARQ feedback signaling (e.g., all feedback signaling is conveyed via RLC status report signaling). In some examples, when the UE is operating according to mode 2, the UE may support nominal feedback protocols of HARQ feedback signaling. The UE may adopt one of mode 1, or mode 2, may alternate between mode 1 and mode 2, or may operate according to a combination of mode 1 and mode 2.

In some examples, the UE may stop transmitting any feedback signaling after successfully receiving a sufficient amount of the outer coded message (e.g., when the UE has received a sufficient quantity of segments of the outer coded transmission, such that no additional signaling, and no retransmission, is necessary). For example, the UE may refrain from transmitting any feedback signaling (e.g., in mode 1 or mode 2) after a final PDSCH (e.g., monitored by the network entity), or after a successful decoding (e.g., as detected by the network entity after processing the feedback reported by the UE). Accordingly, the UE may go to sleep (e.g., enter an idle mode or sleep mode) upon the final PDSCH or after successfully decoding the transmission or after transmitting the feedback message (e.g., in mode 1 or mode 2) indicating successful reception or decoding of the transmission. In some examples, upon successful decoding or after the last PDSCH associated with the received transmission, carrier aggregation functionalities, an outer coding mode, or both, may be de-activated.

At a transmitting device RLC layer (e.g., at a network entity), the transmitting device may receive feedback signaling (e.g., on a primary component carrier), and may calculate a number of received RLC PDU packets (e.g., at the receiving device, such as a UE, as indicated in the feedback signaling). For instance, the initial transmission may include two legs (e.g., two portions or segments. The receiving device may transmit three RLC status reports (e.g., on the primary cell). Each transport block (TB) may include a number of RLC PDUs (e.g., N). Feedback from the receiving device (e.g., the UE) may indicate that a number of RLC PDUs has been received successfully (e.g., such that (N−3)(3 RLC Status Reports=N−3 RLC PDUs successfully received).

Similarly, for a transmission with two legs and a receiving device transmitting one ACK and one NACK message on a primary cell, where each TB includes N RLC PDUs, feedback from the receiving device may indicate to the transmitter that N RLC PDUs have been received successfully. If a number of received RLC PDU packets includes a number of coded segments that satisfies (e.g., is greater than or equal to) a threshold number of RLC PDU packets (e.g., N_{req}) to decode the source segments and reassemble the PDCP PDU, then one or more actions may be triggered. For example, the network entity may de-activate carrier aggregation and the outer coding (e.g., PDCP split outer coding), and may stop transmission of remaining packets of the downlink sequence. IN some examples, if there is no other ongoing traffic, then mode 1, mode 2, or both, may be deactivated. In some examples, if there is no other ongoing traffic, then the network entity may request that the UE enter a sleep mode (e.g., may transmit a message indicating that the UE is to enter sleep mode). The quantity of RLC segments of the threshold (e.g., N_{req}) may depend on an outer code design, may be determined from other upper layer metrics (e.g., radio conditions, quality of service (QoS), quality of experience (QOE), among other examples. For example, for some outer codes (e.g., for MDS code), N_{req} may be equal to the code dimension.

In some examples, techniques described herein may be combined or may interact with one or more additional protocols. For example, the network entity and the UE may deactivate HARQ and RLC retransmissions, or the UE may enter a sleep mode, based on an indication (e.g., a “go to sleep” field or indication in a downlink control information (DCI) message).

Feedback signaling according to mode 1, mode 2, or both, may improve power consumption and decrease latency. For example, as described herein, the UE may operate according to a traffic reduction protocol with HARQ-less protocol (e.g., may transmit RLC status reports conveying feedback information, without HARQ signaling). The UE and the network entity may deactivate HARQ and RLC retransmissions protocols, and a coding rate may be established based on a worst-case scenario. If decoding is detected as successful (e.g., by the base station based on processing the feedback), then the transmitting device may be triggered to stop downlink transmissions, resulting in reduced delays, and to de-activate carrier aggregation functionalities, outer coding transmissions, or both, earlier than without having processed such feedback. If transmissions fail in delivery (e.g., as indicated by feedback), then the network entity may introduce increased redundancy by triggering a rateless feature in the outer encoding by the network entity.

If the UE supports feedback reduction protocols in the uplink, then reduced feedback may be used based on either alternating RLC status reports with HARQ feedback signaling in the feedback mechanism of carrier aggregation scenarios. RLC feedback may occur more frequency than HARQ feedback signaling. Feedback reduction may enable more efficient utilization of PUCCH resources. Feedback may be aggregated over all component carriers of a cell group, and may be sent on the primary cell for one cell group associated with a particular DU. Feedback reduction, resulting in traffic reduction, may enable the UE to enter sleep mode when decoding is detected as successful (e.g., by the network entity based on received feedback signaling).

In some examples, the UE may provide feedback signaling according to periodicity, where the use of RLC status feedback occurs more often than HARQ feedback. ACK/NACK signaling may be used to enable other system mechanisms (e.g., other than actually transmitting feedback corresponding to received downlink data signaling), such as HARQ BLER control loops with the network entity, or detection of control signaling (e.g., indications of missed PDCCH signaling), among other examples. In some examples, ACK/NACK feedback may be configured (e.g., by the network entity), as being optional. RCL status feedback signaling may be sufficient to process, by the transmitter, how many segments have been received correctly by the receiving device (e.g., the UE). In some examples, an optimal periodicity (e.g., for transmitting RLC feedback and HARQ feedback by the UE) may be determined heuristically (e.g., by simulation), may be defined by one or more standards, may be selected or indicated by the network entity, or selected by the UE. Such a periodicity may improve power savings and resources savings. In some examples, the UE may be transmit feedback signaling according to an aperiodic mode (e.g., triggered by control signaling, such as DCI signaling, instead of according to a configured or selected periodicity).

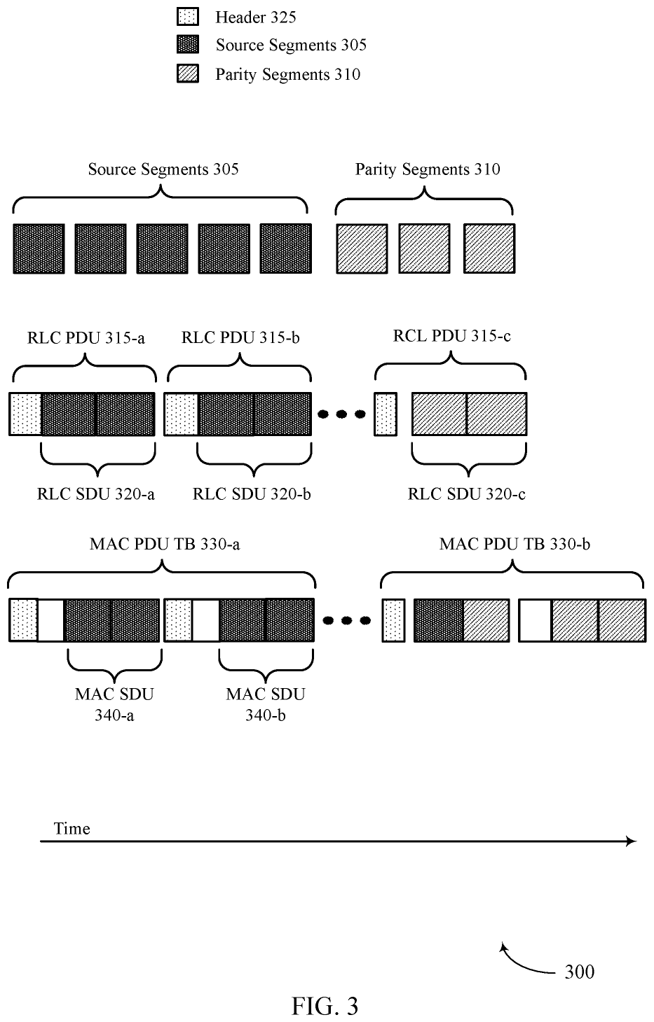

FIG. 3 illustrates an example of a timeline 300 that supports feedback signaling in carrier aggregation and outer coding scenarios in accordance with one or more aspects of the present disclosure. Timeline 300 may implement aspects of, or may be implemented by aspects of, the wireless communications system 100 and the wireless communications system 200. For example, a transmitting device (e.g., a network entity) and a receiving device (e.g., a UE), which may be examples of corresponding devices described with reference to FIG. 1 and FIG. 2), may communicate with each other according to the timeline 300.

A transmitting device (e.g., the network entity) may generate a downlink transmission with a quantity of source segments 305 (e.g., source segments K, where K=5). The transmission may include a total number of coded segments N (e.g., where N=8) including five source segments 305 and three parity segments 310). The network entity may perform outer coding of the source segments 305, and may generate one or more RLC PDUs 315, one or more MACPDU TBs 330, or a combination thereof. Each RLC PDU 315 may include a header 325, and two coded segments (e.g., in one or more RLC SDUs 320). For instance, a first RLC PDU 315-a may include two source code segments 305 (e.g., in one or more RLC SDUs 320-a), another RCL PDU 315-b may include two source segments 305 (e.g., in one or more RLC SUDs 320-b), etc. Another RLC PDU 315-c may include parity segments 310 (e.g., in one or more RLC SDUs 320-c). Each MAC PDU 330 may include four coded segments (e.g., source segments 305, parity segments 310, or both), and one or more headers 325. For example, a first MAC PDU TB 330-a carried via a first CC (e.g., CC1) may include four source segments 305 (e.g., two source segments in a first MAC SDU 340-a and two source segments in a second MAC SDU 340-b), and a second MAC PDU TB 330-b carried via a second CC (e.g., CC2) may include four segments (e.g., one source segment 305 and three parity segments 310 carried via one or more MAC SDUs 340).

At the receiver side, a single ACK message may indicate reception of four coded segments on one TB (e.g., may indicate reception of four coded segments for MAC PDU TB 330-a). One RLC status report message may indicate non-reception of two coded segments on the indicated TB. Thus, an indication of non-reception of two coded segments for a given TB indicates implicit reception of two coded segments. Therefore, if the UE is operating in mode 2, and if the UE transmits feedback including one ACK message on one leg of the transmission and one NACK message related to the other leg (e.g., the ACK message corresponding to the MAC PDU TB 330-a and the NACK message corresponding to the MAC PDU TB 330-b), the feedback signaling may indicate that the UE received 4 coded segments, but is not able to retrieve the source package (e.g., because with K=5, the UE may be able to decode the transmission if at least five coded segments are received). If the UE transmits feedback via RLC status reports (e.g., in mode 1), the UE may transmit feedback in one RLC status report per leg. For example, the UE may indicate that it has received 6 coded segments (e.g., may indicate non-reception of only two segments of eight segments, or may not indicate any non-reception of RLC PDU 315-a, RLC PDU 315-b, and RLC PDU 315-c, each of which corresponds to two coded segments). In such examples, the RLC status report messages may indicate that the UE is able to retrieve the source packet (e.g., because six received coded segments satisfies K=5).

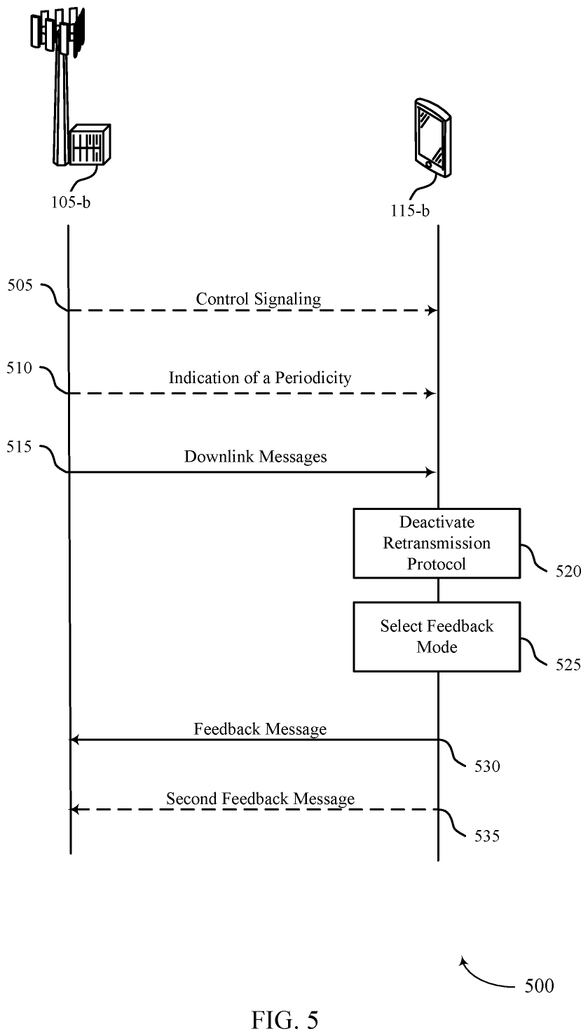

Techniques described herein may be performed by any transmitting device and receiving device. For example, the transmitting device described herein may be a UE and the receiving device may be a network entity. In some examples, as described in greater detail with reference to FIG. 5, the UE may enter a sleep mode upon successful reception of downlink signaling.

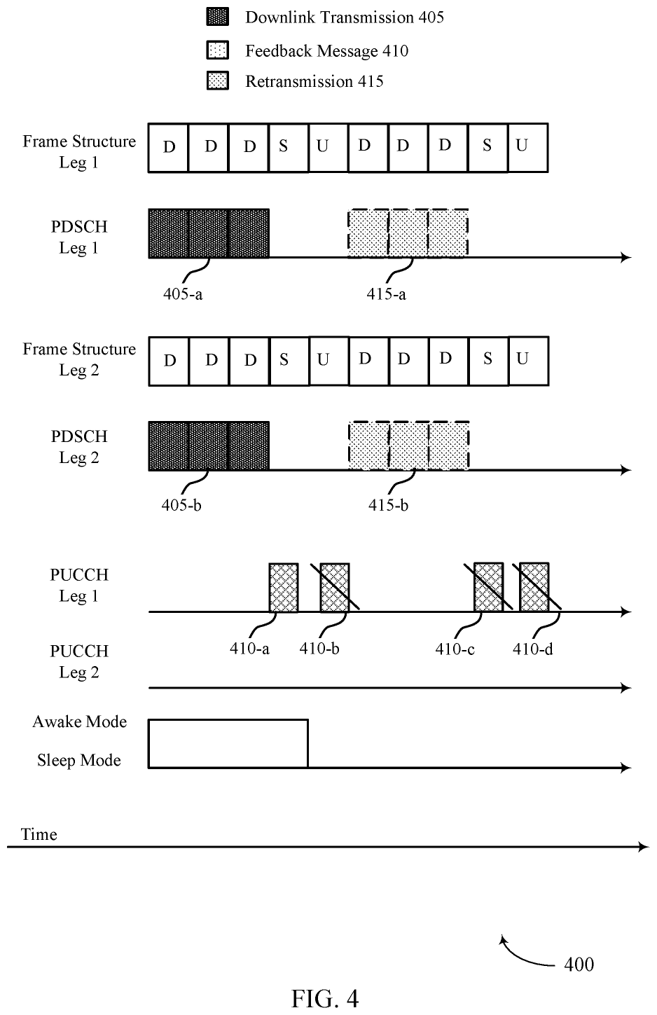

FIG. 4 illustrates an example of a timeline 400 that supports feedback signaling in carrier aggregation and outer coding scenarios in accordance with one or more aspects of the present disclosure. Timeline 400 may implement aspects of, or may be implemented by aspects of, the wireless communications system 100 and the wireless communications system 200. For example, a transmitting device (e.g., a network entity) and a receiving device (e.g., a UE), which may be examples of corresponding devices described with reference to FIG. 1 and FIG. 2), may communicate with each other according to the timeline 400.

The network entity and the UE may communicate according to a frame structure, which may define uplink (U), downlink (D), and special (S) or flexible time durations (e.g., slots or symbols). For example, the frame structure may define a pattern of U, D, and S slots, such as DDDSU (e.g., three downlink slots, followed by a special slot, followed by an uplink slot). The frame structure may include a repeating pattern (e.g., DDDSUDDDSU).

During downlink slots, the network entity may transmit downlink transmissions 405 (e.g., outer coded downlink signaling, as described in greater detail with reference to FIG. 2 and FIG. 3). The network entity may transmit the downlink transmissions 405-a via a first leg (leg 1) and the downlink transmission 405-b via a second leg (leg 2) of the transmissions (e.g., via CC1 and CC2, as described in greater detail with reference to FIG. 2 and FIG. 3). During an special slots and uplink slots, according to the frame structure, the UE may be configured to transmit feedback messages 410 (e.g., an RLC status report according to mode 1, a HARQ feedback message according to mode 2). The feedback message 410-a (e.g., transmitted via a special slot) may indicate that the UE has received sufficient coded segments via the downlink transmission 405-a and the downlink transmission 405-b to decode a downlink message. For example, the feedback information may confirm an acknowledged reception of at least 6 downlink segments (e.g., frames, TBs, MAC PDUs, etc., in the case of one TB per downlink slot per user). The UE may transmit the feedback message 410-a via the PUCCH leg 1 (e.g., via a primary cell or primary carrier for a given DU). The feedback on PUCCH leg 1 may indicate feedback information for the downlink transmissions 405 via both PDSCH leg 1 and PDSCH leg 2.

If the feedback message 410-a indicates that the UE has received enough coded segments to retrieve the source segments of the downlink message, the UE may enter a sleep mode (e.g., light sleep mode, or deep sleep mode, among other examples). In such examples (e.g., based on the feedback message 410-a), the UE may enter sleep mode (e.g., prior to the uplink slot in which the UE might have otherwise transmitted an additional feedback message 410-b). The UE may refrain from transmitting additional feedback message 410-b, feedback message 410-c, and feedback message 410-d (e.g., while in sleep mode after transmission of the feedback message 410-a). The UE and the network entity may also deactivate retransmission protocols. For example, the network entity may have configured the UE for receiving retransmission 415 of the downlink message in subsequent downlink slots. However, based on reception of the feedback message 410-a indicating successful reception of enough segments to decode the source segments, the network entity may refrain from transmitting retransmission 415-a (e.g., of the downlink transmission 405-a) via PDSCH leg 1, and retransmission 415-b (e.g., of the downlink transmission 405-b) via PDSCH leg 2. Refraining from transmission of additional (e.g., and unnecessary) feedback messages 410, and unnecessary retransmissions 415, may result in increased power savings for the UE, increased system efficiency, decreased signaling overhead, improved throughout (e.g., where resources for feedback messages 410 and retransmissions 415 may be repurposed for additional communications), decreased system latency, and improved user experience.

Techniques described herein may be performed by any transmitting device and receiving device. For example, the transmitting device described herein may be a UE and the receiving device may be a network entity.

FIG. 5 illustrates an example of a process flow 500 that supports feedback signaling in carrier aggregation and outer coding scenarios in accordance with one or more aspects of the present disclosure. Process flow 500 may implement aspects of, or may be implemented by aspects of, the wireless communications system 100 and the wireless communications system 200, as well as timeline 300 and timeline 400. For example, a transmitting device (e.g., a network entity 105-b) and a receiving device (e.g., a UE 115-b), which may be examples of corresponding devices described with reference to FIGS. 1-4), may communicate with each other according to the process flow 500. In some examples, although illustrated with reference to the network entity 105-b and the UE 115-b, any devices may communicate according to the process flow 500. For instance, the transmitting device may be a network entity 105 (e.g., instead of the UE 115-b), and the receiving device may be another network entity 105 or a UE 115, or any other wireless device (e.g., a CU, a DU, an RU, an IAB node, among other examples). Techniques described herein may be triggered by the presence of low latency traffic (e.g., may be implemented or triggered by low latency traffic such as ultra-reliable low latency communications (URLLC), XR traffic, among other examples), carrier aggregation with outer coding transmission schemes, or any combination thereof. The outer coding with a coding rate designed for worst link scenario cases, may be used, or rateless coding at a finite code rate (e.g., coding operations may be applied to segments of a PDCP PDU).

At 515, the UE 115-b may receive (e.g., from the network entity 105-b) one or more downlink messages via carrier aggregation in accordance with an outer coding transmission scheme. The outer coding transmission scheme may be any outer coding scheme that distributes redundancy on different legs of a transmission (e.g., via different packets, different frequencies (e.g., different CCs), among other examples). Distributing the redundancy may include, for example, duplication. For example, the outer coding transmission scheme may be an example of a PDCP distribution outer coding scheme, such as a PDCP split outer coding scheme.

At 520, the UE 115-b may deactivate a retransmission protocol associated with the one or more downlink messages based on the outer coding transmission scheme being applied to the one or more downlink messages. The network may deactivate RLC retransmissions when activating carrier aggregation, the outer coding transmission scheme, or both.

At 525, the UE 115-b may select at least one of a first feedback mode (e.g., mode 1) associated with RLC reporting and a first set of resources (e.g., for transmitting the RLC status reports), and a second feedback mode (e.g., mode 2) associated with HARQ reporting and a second set of resources (e.g., for transmitting HARQ signaling). The UE 115-b may select the first feedback mode or the second feedback mode as explicitly instructed by the network entity 105-b (e.g., via control signaling at 505 indicating mode 1 or mode 2), or based on one or more conditions being satisfied. The one or more conditions may include a power status at the UE, a threshold latency corresponding to the one or more downlink messages, or a combination thereof. The conditions may be configured but the network entity 105-b (e.g., at 505), or may be defined in one or more standards. Mode 1 may be referred to as RLC report mode 1. The UE 115-b operating in mode 1 may report RLC status feedback to replace NACK signaling for CA aggregation of feedback of all carrier components on a primary carrier. Mode 2 may be referred to as HARQ report mode 2. The UE 115-b operating in mode 2 may transmit HARQ feedback according to a CA aggregating of feedback of all HARQ feedback for all carriers on a primary carrier. The periodicity of RLC reports may be higher than the HARQ report mode, and the periodicities may be set heuristically.

In some examples, the UE 115-b may select a combination of the first feedback mode and the second feedback mode. The first feedback mode may correspond to a first periodicity, and the second feedback mode may correspond to a second periodicity. The first periodicity may be greater than the second periodicity. In some examples, the UE 115-b may transmit feedback via RLC status reporting more often (e.g., according to the first periodicity) than transmitting HARQ signaling. In some examples, the UE 115-b may transmit HARQ signaling more often (e.g., at a different periodicity) than RLC status reporting.

At 530, the UE 115-b may transmit a feedback message corresponding the one or more downlink messages (e.g., indicating a quantity of coded segments received by the UE 115-b) via the first set of resources (e.g., an RLC status report), or the second set of resources (e.g., a HARQ feedback message) according to the selected feedback mode). In some examples, the UE 115-b may transmit the feedback message at 530 via the first set of resources, according to the first periodicity. The UE 115-b may also transmit a second feedback message at 535 via the second set of resources, according to the second periodicity. The UE 115-b may count a quantity of received RLC PDUs based on processing rules according to the techniques described herein (e.g., and may indicate via the feedback message that a sufficient quantity of RLC PDUs satisfies a threshold, and the UE 115-b has sufficient segments to decode the downlink message). As described herein, the UE 115-b may upon determining that a number of received RLC PDU packets includes a number of coded segments above a specific or threshold number, the UE 115-b may take one or more actions. Such actions may include deactivating CA and the outer coding transmission scheme. If there is no additional, simultaneous, or pending traffic, the UE 115-b may interrupt transmission of remaining segments of the related downlink sequence, deactivate all kinds of RLC and HARQ reporting, and enter a sleep mode.

In some examples, the UE 115-b may alternate between transmitting feedback signaling (e.g., the first feedback message at 530) via respective resources associated with the first set of resources according to the first periodicity, and transmitting feedback signaling (e.g., the second feedback message at 535) via respective resources associated with the second set of resources according to the second periodicity. The UE 115-b may alternate between periodic use of ACK/NACK HARQ signaling and NACK RLC status reporting in carrier aggregation, and may aggregate feedback of all legs of the transmission on a primary CC (e.g., or any designated CC). The periodicity of the RLC status may be higher than that of the HARQ feedback. In some examples, the RLC status reporting periodicity may be lower than that of the HARQ feedback. In some examples, at 510, the UE may receive an indication of the periodicity.

In some examples, the network entity 105-b may configure the UE 115-bwith one or more parameters for operating in mode 1 or mode 2. For example, at 505, the UE 115-b may receive (e.g., from the network entity 105-b) control signaling indicating one or more parameters to use for the first feedback mode, the second feedback mode, or both. In such examples, the UE 115-b may select the feedback mode 525 based on or according to the indicated parameters. The parameters may include one or more rules for adopting mode 1 or mode 2, one or more conditions under which the UE 115-b is to adopt mode 1 or mode 2, a periodicity for transmitting the feedback messages (e.g., at 530 and 535) according to mode 1, mode 2, or both, or any combination thereof.

In some examples, the UE 115-b may activate a first resource of the second set of resources according to the second periodicity, and may transmit, via the activated first resource of the second set of resources, a BLER message, an indication of a missed PUCCH channel, or a combination thereof. For example, the UE 115-a may activate fast NACK RLC status feedback signaling, ignoring one or more timers (e.g., t_Reassembly, and t_StatusProhibit) or allowing the timers to expire while following the feedback signaling techniques in mode 1 or mode 2. In some examples, a few HARQ feedback messages or resources may be activated periodically, and may support BLER control loop, detection of missed PUCCH, etc.

In some examples, transmitting the feedback message at 530 may include transmitting an RLC status report via the first set of resources according to the firs feedback mode based on detecting a missed RLC PDU. The UE 115-b may deactivate HARQ protocol associated with the second feedback mode according to the selection at 525, The UE 115-a may allow one or more timers to expire, or may set the one or more timers to zero, based on selecting the first feedback mode, where the timers are associated with RLC status reporting. The UE 115-b may include, in the RLC status report, an indication of a quantity of segments associated with the outer coding transmission scheme that have been successfully received by the UE 115-b (e.g., or may indicate non-received segments, implicitly indicating successfully received segments).

In some examples, the UE 115-b may transmit multiple feedback messages (e.g., at 530 and at 535) via the first set of resources via a primary CC for a first cell group, and via a second set of resources of the primary CC for the first cell group. In some examples, the feedback message may be generated according to a HARQ codebook (e.g., type 1 or type 2). Methods and techniques described herein may apply to multiple cell groups via multiple DUs. Techniques described herein may apply on each cell group independently.

In some examples, upon transmitting the feedback message at 530, the UE 115-b may enter a sleep mode based on transmitting the feedback message, and may deactivate CA, the outer coding transmission scheme, or both based on having entered the sleep mode. The network entity 105-b may similarly deactivate the carrier aggregation mode and the outer coding transmission scheme based on receiving the feedback message at 530, or upon transmitting the last of the downlink messages at 515. The UE 115-b may refrain from transmitting one or more additional feedback messages (e.g., at 535) via at least a portion of the first set of resources and the second set of resources associated with retransmissions of the one or more downlink messages based on entering the sleep mode. In some cases, the UE 115-b may receive, from the network entity based on having transmitted the feedback message at 530, an indication that no additional downlink messages are pending, and the UE 115-a may enter the sleep mode based on receiving the indication. In some cases, the UE 115-b may receive, from the network entity 105-b, an indication of a threshold quantity of segments (e.g., K) associated with the outer coding transmission scheme, and may enter the sleep mode based on determining that a quantity of coded segments in the downlink messages satisfying the threshold quantity of segments indicated by the network entity 105-b. In some examples, the threshold quantity of segments may be defined in one or more standards.

The network entity 105-b may refrain from transmitting one or more retransmissions, or one or more additionally scheduled segments of the downlink message based on determining that the UE 115-b has received a sufficient (e.g., threshold) quantity of segments to decode the downlink message. In some cases, the network entity 105-b may determine that such is the case based on receiving the feedback message at 530, or based on transmitting a last PDSCH message at 515. In some cases, the network entity 105-b may transmit the indication that no pending transmissions will be sent based on the determination.

In some examples, the network entity 105-b may transmit, and the UE 115-bmay receive, control signaling (e.g., at 505) triggering an aperiodic feedback signaling via the first set of resources, the second set of resources, or both. The UE 115-b may transmit the feedback signaling periodically at 530 based on the control signaling. In some cases, the dynamic trigger may indicate a feedback mode, and the UE 115-b may select the feedback mode at 525 based thereon. In some examples, the dynamic trigger may indicate an instruction to enter the sleep mode, and the UE 115-b may do so after transmitting the feedback message based on the control signaling.

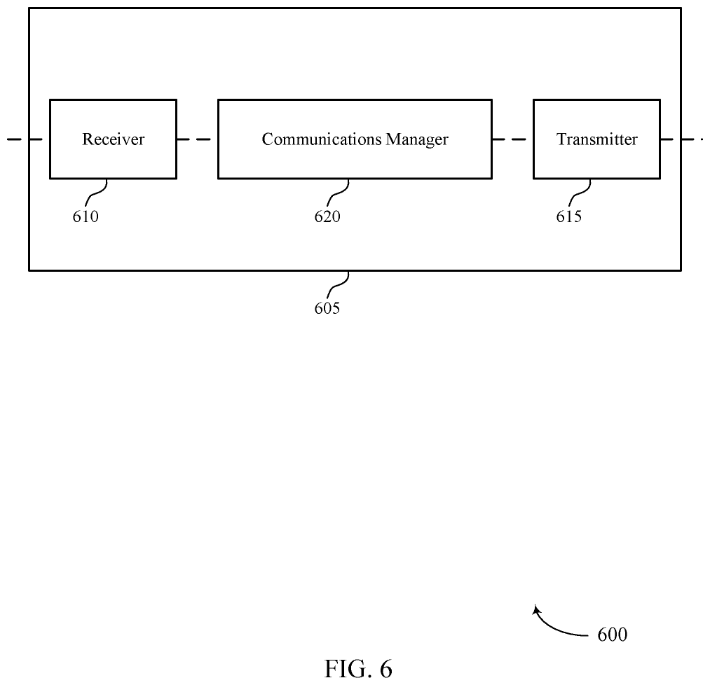

FIG. 6 illustrates a block diagram 600 of a device 605 that supports feedback signaling in carrier aggregation and outer coding scenarios in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to feedback signaling in carrier aggregation and outer coding scenarios). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to feedback signaling in carrier aggregation and outer coding scenarios). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of feedback signaling in carrier aggregation and outer coding scenarios as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving, via carrier aggregation, one or more downlink messages from a network entity in accordance with an outer coding transmission scheme. The communications manager 620 may be configured as or otherwise support a means for deactivating a retransmission protocol associated with the one or more downlink messages based on the outer coding transmission scheme being applied to the one or more downlink messages. The communications manager 620 may be configured as or otherwise support a means for selecting, based on the outer coding transmission scheme being applied to the one or more downlink messages, at least one of a first feedback mode associated with RLC reporting and a first set of resources or a second feedback mode associated with hybrid-automatic request reporting and a second set of resources. The communications manager 620 may be configured as or otherwise support a means for transmitting a feedback message corresponding to the one or more downlink messages via the first set of resources or the second set of resources according to the selected feedback mode.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for feedback signaling for outer coding scenarios resulting in increased power savings, increased system efficiency, decreased signaling overhead, improved throughout, decreased system latency, and improved user experience.

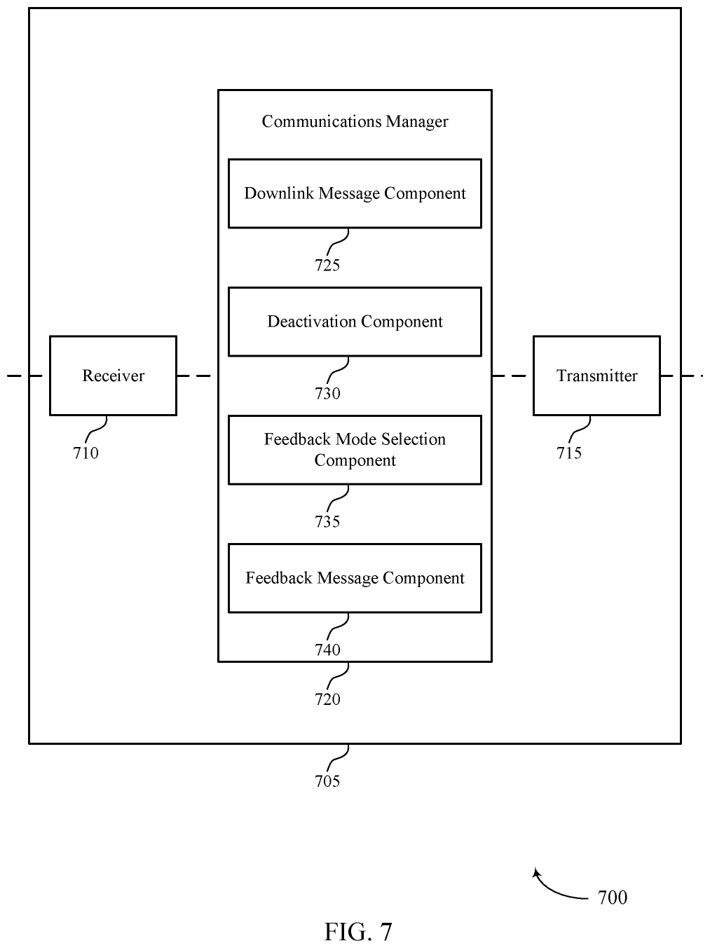

FIG. 7 illustrates a block diagram 700 of a device 705 that supports feedback signaling in carrier aggregation and outer coding scenarios in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to feedback signaling in carrier aggregation and outer coding scenarios). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to feedback signaling in carrier aggregation and outer coding scenarios). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of feedback signaling in carrier aggregation and outer coding scenarios as described herein. For example, the communications manager 720 may include a downlink message component 725, a deactivation component 730, a feedback mode selection component 735, a feedback message component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The downlink message component 725 may be configured as or otherwise support a means for receiving, via carrier aggregation, one or more downlink messages from a network entity in accordance with an outer coding transmission scheme. The deactivation component 730 may be configured as or otherwise support a means for deactivating a retransmission protocol associated with the one or more downlink messages based on the outer coding transmission scheme being applied to the one or more downlink messages. The feedback mode selection component 735 may be configured as or otherwise support a means for selecting, based on the outer coding transmission scheme being applied to the one or more downlink messages, at least one of a first feedback mode associated with RLC reporting and a first set of resources or a second feedback mode associated with hybrid-automatic request reporting and a second set of resources. The feedback message component 740 may be configured as or otherwise support a means for transmitting a feedback message corresponding to the one or more downlink messages via the first set of resources or the second set of resources according to the selected feedback mode.

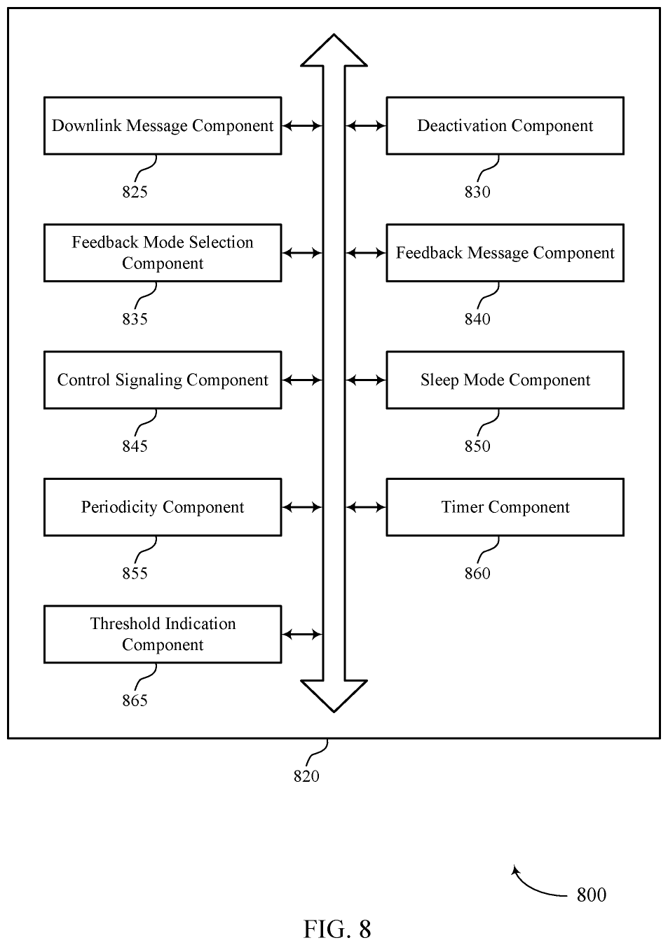

FIG. 8 illustrates a block diagram 800 of a communications manager 820 that supports feedback signaling in carrier aggregation and outer coding scenarios in accordance with one or more aspects of the present disclosure. The communications manager 820 may be an example of aspects of a communications manager 620, a communications manager 720, or both, as described herein. The communications manager 820, or various components thereof, may be an example of means for performing various aspects of feedback signaling in carrier aggregation and outer coding scenarios as described herein. For example, the communications manager 820 may include a downlink message component 825, a deactivation component 830, a feedback mode selection component 835, a feedback message component 840, a control signaling component 845, a sleep mode component 850, a periodicity component 855, a timer component 860, a threshold indication component 865, or any combination thereof. Each of these components may communicate, directly or indirectly, with one another (e.g., via one or more buses).

The communications manager 820 may support wireless communications at a UE in accordance with examples as disclosed herein. The downlink message component 825 may be configured as or otherwise support a means for receiving, via carrier aggregation, one or more downlink messages from a network entity in accordance with an outer coding transmission scheme. The deactivation component 830 may be configured as or otherwise support a means for deactivating a retransmission protocol associated with the one or more downlink messages based on the outer coding transmission scheme being applied to the one or more downlink messages. The feedback mode selection component 835 may be configured as or otherwise support a means for selecting, based on the outer coding transmission scheme being applied to the one or more downlink messages, at least one of a first feedback mode associated with RLC reporting and a first set of resources or a second feedback mode associated with hybrid-automatic request reporting and a second set of resources. The feedback message component 840 may be configured as or otherwise support a means for transmitting a feedback message corresponding to the one or more downlink messages via the first set of resources or the second set of resources according to the selected feedback mode.

In some examples, the control signaling component 845 may be configured as or otherwise support a means for receiving, from the network entity, control signaling indicating one or more parameters for use of the first feedback mode, the second feedback mode, or both, where the selecting is based on the one or more parameters.

In some examples, the feedback mode selection component 835 may be configured as or otherwise support a means for selecting the at least one of the first feedback mode or the second feedback mode based on one or more conditions being satisfied, where the one or more conditions are associated with a power status at the UE, a threshold latency corresponding to the one or more downlink messages, or a combination thereof.

In some examples, to support selecting, the feedback mode selection component 835 may be configured as or otherwise support a means for selecting a combination of the first feedback mode and the second feedback mode, where the first feedback mode corresponds to a first periodicity and the second feedback mode corresponds to a second periodicity, where the first periodicity is greater than the second periodicity.

In some examples, to support transmitting the feedback message, the feedback message component 840 may be configured as or otherwise support a means for transmitting a first feedback message via the first set of resources according to the first periodicity. In some examples, to support transmitting the feedback message, the feedback message component 840 may be configured as or otherwise support a means for transmitting a second feedback message via the second set of resources according to the second periodicity.

In some examples, to support transmitting the feedback message, the feedback message component 840 may be configured as or otherwise support a means for activating a first resource of the second set of resources according to the second periodicity. In some examples, to support transmitting the feedback message, the feedback message component 840 may be configured as or otherwise support a means for transmitting, via the activated first resource of the second set of resources, a block error report, an indication of a missed message via a physical downlink control channel, or a combination thereof.

In some examples, to support transmitting the first feedback message and the second feedback message, the feedback message component 840 may be configured as or otherwise support a means for alternating between transmitting via respective resources associated with the first set of resources and the second set of resources according to the first periodicity and the second periodicity.

In some examples, to support transmitting the feedback message, the feedback message component 840 may be configured as or otherwise support a means for transmitting a RLC status report via the first set of resources according to the first feedback mode based on detecting a missed RLC packet data unit, where a HARQ protocol associated with the second feedback mode is deactivated according to the selecting.

In some examples, the timer component 860 may be configured as or otherwise support a means for allowing one or more timers to expire, or setting the one or more timers to zero, based on selecting the first feedback mode, where the one or more timers are associated with RLC status signaling.

In some examples, the feedback message component 840 may be configured as or otherwise support a means for including, in the RLC status report, an indication of a quantity of segments associated with the outer coding transmission scheme that have been successfully received by the UE.

In some examples, to support transmitting the feedback message, the feedback message component 840 may be configured as or otherwise support a means for transmitting a set of multiple feedback messages via the first set of resources of a primary component carrier for a first cell group and via the second set of resources of the primary component carrier for the first cell group, the set of multiple feedback messages including the feedback message.

In some examples, the feedback message component 840 may be configured as or otherwise support a means for generating the feedback message according to a HARQ codebook type, where transmitting the feedback message is based on the generating.

In some examples, the sleep mode component 850 may be configured as or otherwise support a means for entering a sleep mode based on transmitting the feedback message. In some examples, the deactivation component 830 may be configured as or otherwise support a means for deactivating the carrier aggregation, the outer coding transmission scheme, or both, based on entering the sleep mode.

In some examples, the feedback message component 840 may be configured as or otherwise support a means for refraining from transmitting one or more additional feedback messages via at least a portion of the first set of resources and the second set of resources associated with retransmissions of the one or more downlink messages based on entering the sleep mode during the portion of the first set of resources and the second set of resources, deactivating the retransmission protocol, or both.

In some examples, the feedback message component 840 may be configured as or otherwise support a means for receiving, from the network entity based on transmitting the feedback message, an indication that no additional downlink messages are pending, where entering the sleep mode is based on receiving the indication.

In some examples, the threshold indication component 865 may be configured as or otherwise support a means for receiving, from the network entity, an indication of a threshold quantity of segments associated with the outer coding transmission scheme, where entering the sleep mode is based on the quantity of segments associated with the outer coding transmission scheme that have been successfully received by the UE satisfies the threshold quantity of segments.

In some examples, the periodicity component 855 may be configured as or otherwise support a means for receiving, from the network entity, an indication of a periodicity associated with the first feedback mode, the second feedback mode, or a combination thereof, where transmitting the feedback message is based on the periodicity.

In some examples, the control signaling component 845 may be configured as or otherwise support a means for receiving control signaling triggering aperiodic feedback signaling via the first set of resources or the second set of resources, where transmitting the feedback message is based on receiving the control signaling.

In some examples, the control signaling component 845 may be configured as or otherwise support a means for receiving control signaling indicating a carrier aggregation mode, an instruction to deactivate RLC retransmissions, or a combination thereof.

In some examples, the outer coding transmission scheme includes a PDCP distribution outer coding scheme associated with a threshold link quality.

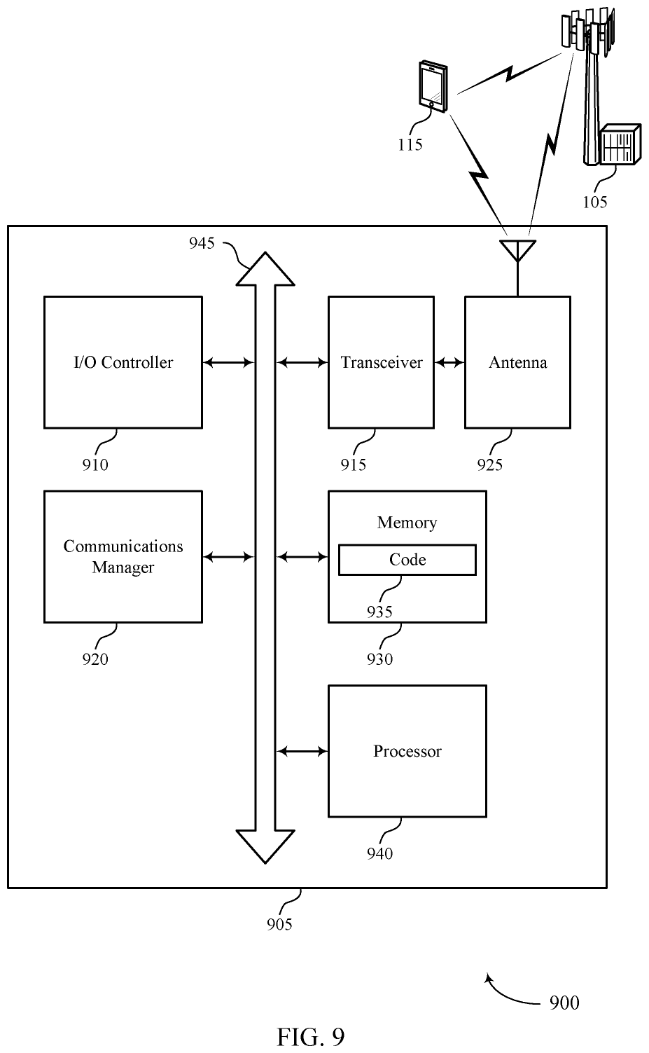

FIG. 9 illustrates a diagram of a system 900 including a device 905 that supports feedback signaling in carrier aggregation and outer coding scenarios in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting feedback signaling in carrier aggregation and outer coding scenarios). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving, via carrier aggregation, one or more downlink messages from a network entity in accordance with an outer coding transmission scheme. The communications manager 920 may be configured as or otherwise support a means for deactivating a retransmission protocol associated with the one or more downlink messages based on the outer coding transmission scheme being applied to the one or more downlink messages. The communications manager 920 may be configured as or otherwise support a means for selecting, based on the outer coding transmission scheme being applied to the one or more downlink messages, at least one of a first feedback mode associated with RLC reporting and a first set of resources or a second feedback mode associated with hybrid-automatic request reporting and a second set of resources. The communications manager 920 may be configured as or otherwise support a means for transmitting a feedback message corresponding to the one or more downlink messages via the first set of resources or the second set of resources according to the selected feedback mode.

By including or configuring the communications manager 920 in accordance with examples as described herein, the device 905 may support techniques for feedback signaling for outer coding scenarios resulting in increased power savings, increased system efficiency, decreased signaling overhead, improved throughout, decreased system latency, and improved user experience.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of feedback signaling in carrier aggregation and outer coding scenarios as described herein, or the processor 940 and the memory 930 may be otherwise configured to perform or support such operations.

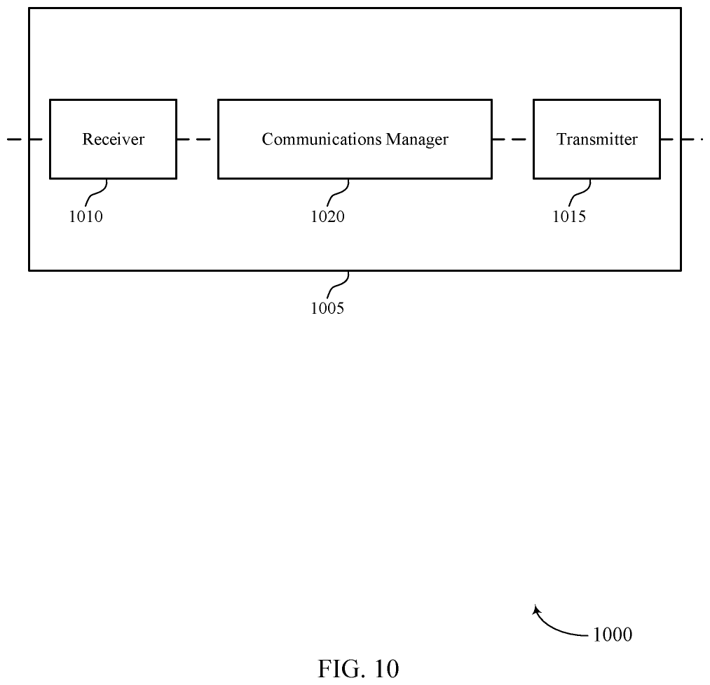

FIG. 10 illustrates a block diagram 1000 of a device 1005 that supports feedback signaling in carrier aggregation and outer coding scenarios in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, PDUs, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, PDUs, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of feedback signaling in carrier aggregation and outer coding scenarios as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for generating one or more downlink messages according to an outer coding transmission scheme. The communications manager 1020 may be configured as or otherwise support a means for transmitting the one or more downlink messages to a UE via carrier aggregation in accordance with the outer coding transmission scheme. The communications manager 1020 may be configured as or otherwise support a means for selecting, based on generating the one or more downlink messages according to the outer coding transmission scheme, at least one of a first feedback mode associated with RLC reporting and a first set of resources or a second feedback mode associated with hybrid-automatic request reporting and a second set of resources. The communications manager 1020 may be configured as or otherwise support a means for receiving a feedback message corresponding to the one or more downlink messages via the first set of resources or the second set of resources according to the selected feedback mode.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for feedback signaling for outer coding scenarios resulting in increased power savings, increased system efficiency, decreased signaling overhead, improved throughout, decreased system latency, and improved user experience.

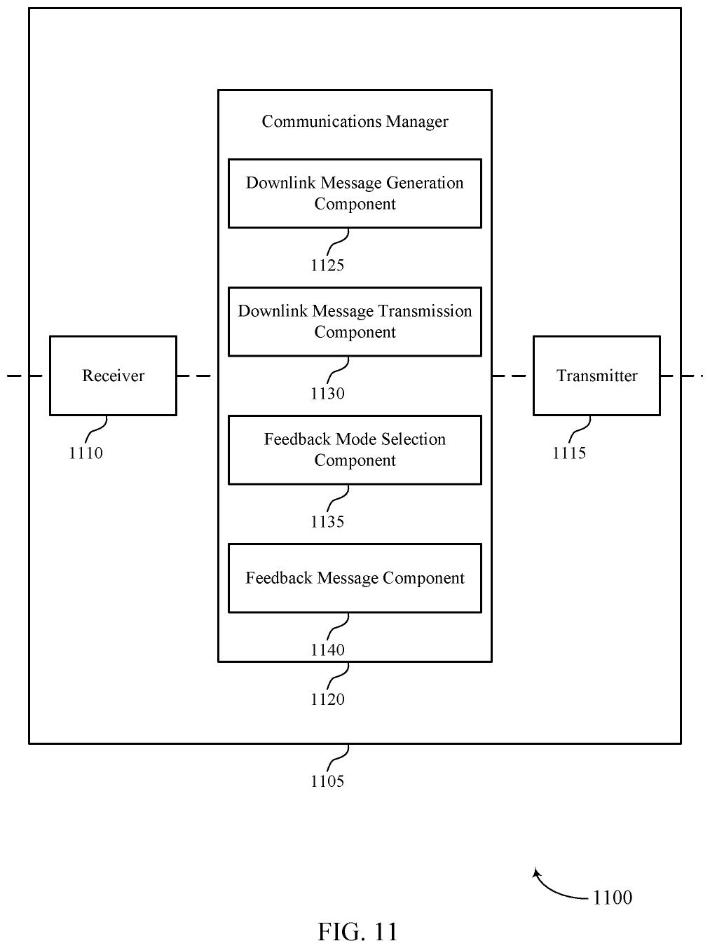

FIG. 11 illustrates a block diagram 1100 of a device 1105 that supports feedback signaling in carrier aggregation and outer coding scenarios in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, PDUs, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, PDUs, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of feedback signaling in carrier aggregation and outer coding scenarios as described herein. For example, the communications manager 1120 may include a downlink message generation component 1125, a downlink message transmission component 1130, a feedback mode selection component 1135, a feedback message component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The downlink message generation component 1125 may be configured as or otherwise support a means for generating one or more downlink messages according to an outer coding transmission scheme. The downlink message transmission component 1130 may be configured as or otherwise support a means for transmitting the one or more downlink messages to a UE via carrier aggregation in accordance with the outer coding transmission scheme. The feedback mode selection component 1135 may be configured as or otherwise support a means for selecting, based on generating the one or more downlink messages according to the outer coding transmission scheme, at least one of a first feedback mode associated with RLC reporting and a first set of resources or a second feedback mode associated with hybrid-automatic request reporting and a second set of resources. The feedback message component 1140 may be configured as or otherwise support a means for receiving a feedback message corresponding to the one or more downlink messages via the first set of resources or the second set of resources according to the selected feedback mode.

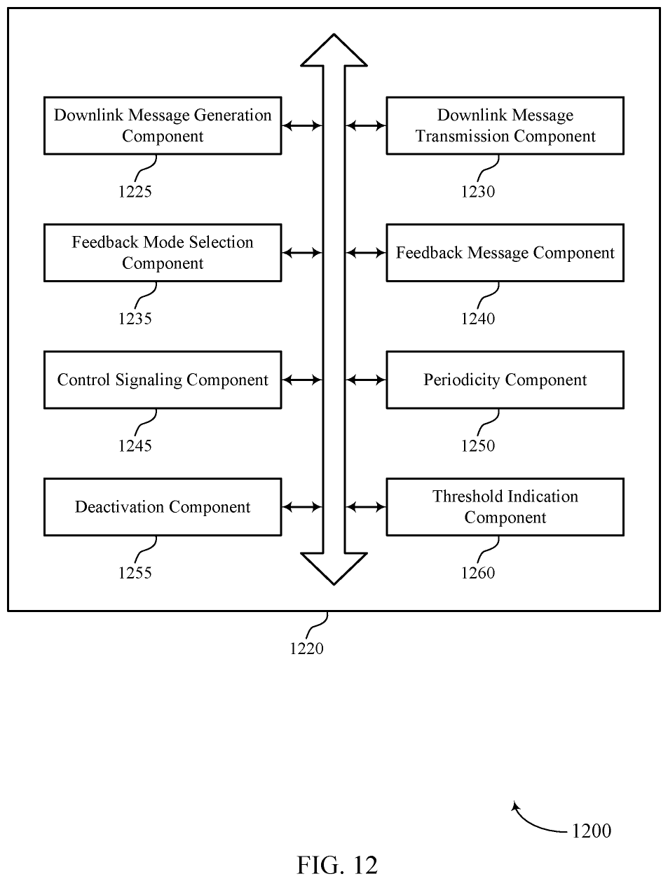

FIG. 12 illustrates a block diagram 1200 of a communications manager 1220 that supports feedback signaling in carrier aggregation and outer coding scenarios in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of feedback signaling in carrier aggregation and outer coding scenarios as described herein. For example, the communications manager 1220 may include a downlink message generation component 1225, a downlink message transmission component 1230, a feedback mode selection component 1235, a feedback message component 1240, a control signaling component 1245, a periodicity component 1250, a deactivation component 1255, a threshold indication component 1260, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The downlink message generation component 1225 may be configured as or otherwise support a means for generating one or more downlink messages according to an outer coding transmission scheme. The downlink message transmission component 1230 may be configured as or otherwise support a means for transmitting the one or more downlink messages to a UE via carrier aggregation in accordance with the outer coding transmission scheme. The feedback mode selection component 1235 may be configured as or otherwise support a means for selecting, based on generating the one or more downlink messages according to the outer coding transmission scheme, at least one of a first feedback mode associated with RLC reporting and a first set of resources or a second feedback mode associated with hybrid-automatic request reporting and a second set of resources. The feedback message component 1240 may be configured as or otherwise support a means for receiving a feedback message corresponding to the one or more downlink messages via the first set of resources or the second set of resources according to the selected feedback mode.

In some examples, the control signaling component 1245 may be configured as or otherwise support a means for transmitting, to the UE, control signaling indicating one or more parameters for use of the first feedback mode, the second feedback mode, or both, where the selecting is based on the one or more parameters.

In some examples, the feedback mode selection component 1235 may be configured as or otherwise support a means for selecting the at least one of the first feedback mode and the second feedback mode based on one or more conditions being satisfied, where the one or more conditions are associated with a power status at the UE, a threshold latency corresponding to the one or more downlink messages, or a combination thereof.

In some examples, to support selecting, the feedback mode selection component 1235 may be configured as or otherwise support a means for selecting a combination of the first feedback mode and the second feedback mode, where the first feedback mode corresponds to a first periodicity and the second feedback mode corresponds to a second periodicity, where the first periodicity is greater than the second periodicity.

In some examples, to support receiving the feedback message, the feedback message component 1240 may be configured as or otherwise support a means for receiving a first feedback message via the first set of resources according to the first periodicity. In some examples, to support receiving the feedback message, the feedback message component 1240 may be configured as or otherwise support a means for receiving a second feedback message via the second set of resources according to the second periodicity.

In some examples, to support receiving the first feedback message and the second feedback message, the feedback message component 1240 may be configured as or otherwise support a means for alternating between receiving via respective resources associated with the first set of resources and the second set of resources according to the first periodicity and the second periodicity.

In some examples, to support receiving the feedback message, the feedback message component 1240 may be configured as or otherwise support a means for receiving a RLC status report via the first set of resources according to the first feedback mode indicating a missed RLC packet data unit, where a HARQ protocol associated with the second feedback mode is deactivated according to the selecting.

In some examples, the feedback message component 1240 may be configured as or otherwise support a means for receiving, in the RLC status report, an indication of a quantity of segments associated with the outer coding transmission scheme that have been successfully received by the UE.

In some examples, the threshold indication component 1260 may be configured as or otherwise support a means for transmitting, to the UE, an indication of a threshold quantity of segments associated with the outer coding transmission scheme. In some examples, the threshold indication component 1260 may be configured as or otherwise support a means for refraining from transmitting one or more additional segments associated with the outer coding transmission scheme based on the quantity of segments associated with the outer coding transmission scheme satisfying the threshold quantity of segments.

In some examples, to support receiving the feedback message, the feedback message component 1240 may be configured as or otherwise support a means for receiving a set of multiple feedback messages via the first set of resources of a primary component carrier for a first cell group and via the second set of resources of the primary component carrier for the first cell group, the set of multiple feedback messages including the feedback message.

In some examples, to support receiving the feedback message, the feedback message component 1240 may be configured as or otherwise support a means for receiving the feedback message according to a HARQ codebook type.

In some examples, the downlink message transmission component 1230 may be configured as or otherwise support a means for refraining from transmitting one or more additional downlink messages based on receiving the feedback message. In some examples, the feedback message component 1240 may be configured as or otherwise support a means for refraining from monitoring for one or more additional feedback messages during at least a portion of the first set of resources, the second set of resources, or both.

In some examples, the deactivation component 1255 may be configured as or otherwise support a means for deactivating a retransmission protocol associated with the one or more downlink messages, where refraining from transmitting the one or more additional downlink messages is based on the deactivating.

In some examples, the downlink message transmission component 1230 may be configured as or otherwise support a means for transmitting, to the UE, an indication that the one or more additional downlink messages are not pending, where refraining from transmitting the one or more additional downlink messages is based on receiving the indication.

In some examples, the periodicity component 1250 may be configured as or otherwise support a means for transmitting, to the UE, an indication of a periodicity associated with the first feedback mode, the second feedback mode, or a combination thereof, where receiving the feedback message is based on the periodicity.

In some examples, the control signaling component 1245 may be configured as or otherwise support a means for transmitting control signaling triggering aperiodic feedback signaling via the first set of resources or the second set of resources, where receiving the feedback message is based on receiving the control signaling.

In some examples, the control signaling component 1245 may be configured as or otherwise support a means for transmitting control signaling indicating a carrier aggregation mode, an instruction to deactivate RLC retransmissions, or a combination thereof.

In some examples, the outer coding transmission scheme includes a PDCP distribution outer coding scheme associated with a threshold link quality.

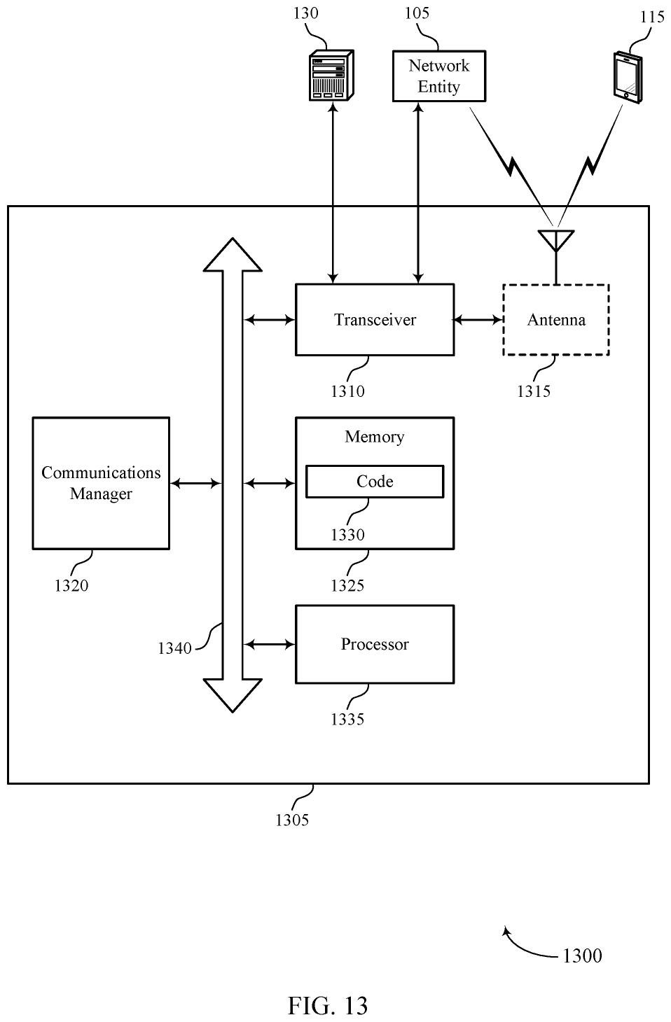

FIG. 13 illustrates a diagram of a system 1300 including a device 1305 that supports feedback signaling in carrier aggregation and outer coding scenarios in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting feedback signaling in carrier aggregation and outer coding scenarios). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for generating one or more downlink messages according to an outer coding transmission scheme. The communications manager 1320 may be configured as or otherwise support a means for transmitting the one or more downlink messages to a UE via carrier aggregation in accordance with the outer coding transmission scheme. The communications manager 1320 may be configured as or otherwise support a means for selecting, based on generating the one or more downlink messages according to the outer coding transmission scheme, at least one of a first feedback mode associated with RLC reporting and a first set of resources or a second feedback mode associated with hybrid-automatic request reporting and a second set of resources. The communications manager 1320 may be configured as or otherwise support a means for receiving a feedback message corresponding to the one or more downlink messages via the first set of resources or the second set of resources according to the selected feedback mode.

By including or configuring the communications manager 1320 in accordance with examples as described herein, the device 1305 may support techniques for feedback signaling for outer coding scenarios resulting in increased power savings, increased system efficiency, decreased signaling overhead, improved throughout, decreased system latency, and improved user experience.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of feedback signaling in carrier aggregation and outer coding scenarios as described herein, or the processor 1335 and the memory 1325 may be otherwise configured to perform or support such operations.

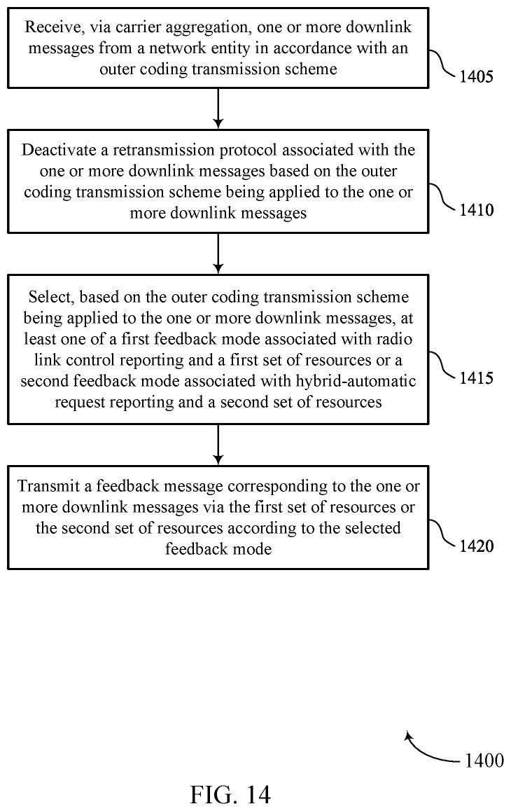

FIG. 14 illustrates a flowchart showing a method 1400 that supports feedback signaling in carrier aggregation and outer coding scenarios in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, via carrier aggregation, one or more downlink messages from a network entity in accordance with an outer coding transmission scheme. The operations of 1405 may be performed in accordance with examples as disclosed herein. In some examples, aspects of the operations of 1405 may be performed by a downlink message component 825 as described with reference to FIG. 8.

At 1410, the method may include deactivating a retransmission protocol associated with the one or more downlink messages based on the outer coding transmission scheme being applied to the one or more downlink messages. The operations of 1410 may be performed in accordance with examples as disclosed herein. In some examples, aspects of the operations of 1410 may be performed by a deactivation component 830 as described with reference to FIG. 8.

At 1415, the method may include selecting, based on the outer coding transmission scheme being applied to the one or more downlink messages, at least one of a first feedback mode associated with RLC reporting and a first set of resources or a second feedback mode associated with hybrid-automatic request reporting and a second set of resources. The operations of 1415 may be performed in accordance with examples as disclosed herein. In some examples, aspects of the operations of 1415 may be performed by a feedback mode selection component 835 as described with reference to FIG. 8.

At 1420, the method may include transmitting a feedback message corresponding to the one or more downlink messages via the first set of resources or the second set of resources according to the selected feedback mode. The operations of 1420 may be performed in accordance with examples as disclosed herein. In some examples, aspects of the operations of 1420 may be performed by a feedback message component 840 as described with reference to FIG. 8.

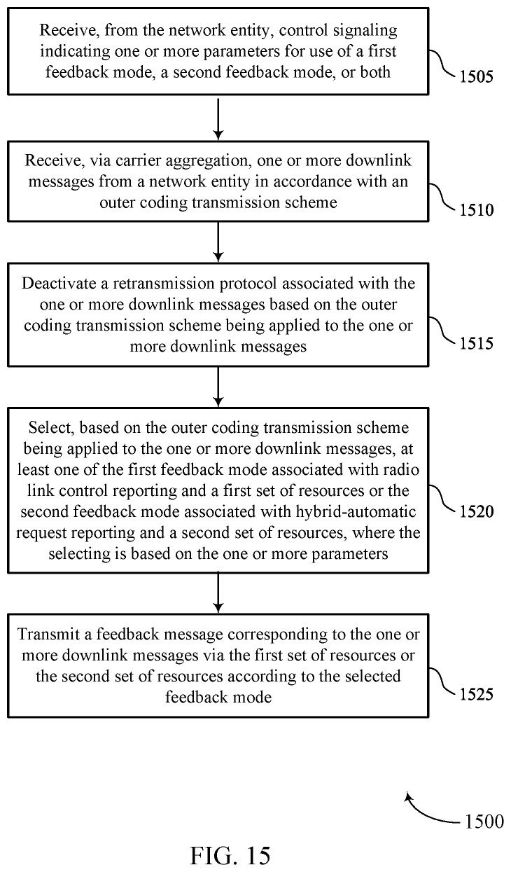

FIG. 15 illustrates a flowchart showing a method 1500 that supports feedback signaling in carrier aggregation and outer coding scenarios in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from the network entity, control signaling indicating one or more parameters for use of a first feedback mode, a second feedback mode, or both. The operations of 1505 may be performed in accordance with examples as disclosed herein. In some examples, aspects of the operations of 1505 may be performed by a control signaling component 845 as described with reference to FIG. 8.

At 1510, the method may include receiving, via carrier aggregation, one or more downlink messages from a network entity in accordance with an outer coding transmission scheme. The operations of 1510 may be performed in accordance with examples as disclosed herein. In some examples, aspects of the operations of 1510 may be performed by a downlink message component 825 as described with reference to FIG. 8.

At 1515, the method may include deactivating a retransmission protocol associated with the one or more downlink messages based on the outer coding transmission scheme being applied to the one or more downlink messages. The operations of 1515 may be performed in accordance with examples as disclosed herein. In some examples, aspects of the operations of 1515 may be performed by a deactivation component 830 as described with reference to FIG. 8.

At 1520, the method may include selecting, based on the outer coding transmission scheme being applied to the one or more downlink messages, at least one of the first feedback mode associated with RLC reporting and a first set of resources or the second feedback mode associated with hybrid-automatic request reporting and a second set of resources, where the selecting is based on the one or more parameters. The operations of 1520 may be performed in accordance with examples as disclosed herein. In some examples, aspects of the operations of 1520 may be performed by a feedback mode selection component 835 as described with reference to FIG. 8.

At 1525, the method may include transmitting a feedback message corresponding to the one or more downlink messages via the first set of resources or the second set of resources according to the selected feedback mode. The operations of 1525 may be performed in accordance with examples as disclosed herein. In some examples, aspects of the operations of 1525 may be performed by a feedback message component 840 as described with reference to FIG. 8.

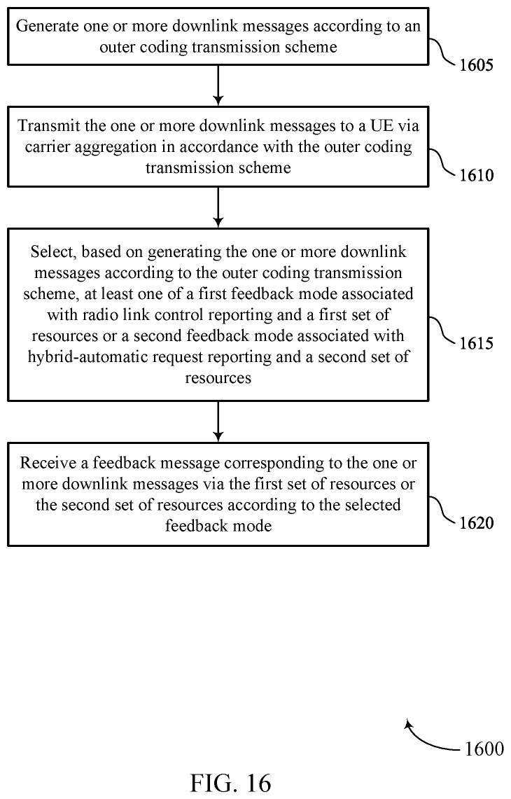

FIG. 16 illustrates a flowchart showing a method 1600 that supports feedback signaling in carrier aggregation and outer coding scenarios in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include generating one or more downlink messages according to an outer coding transmission scheme. The operations of 1605 may be performed in accordance with examples as disclosed herein. In some examples, aspects of the operations of 1605 may be performed by a downlink message generation component 1225 as described with reference to FIG. 12.

At 1610, the method may include transmitting the one or more downlink messages to a UE via carrier aggregation in accordance with the outer coding transmission scheme. The operations of 1610 may be performed in accordance with examples as disclosed herein. In some examples, aspects of the operations of 1610 may be performed by a downlink message transmission component 1230 as described with reference to FIG. 12.

At 1615, the method may include selecting, based on generating the one or more downlink messages according to the outer coding transmission scheme, at least one of a first feedback mode associated with RLC reporting and a first set of resources or a second feedback mode associated with hybrid-automatic request reporting and a second set of resources. The operations of 1615 may be performed in accordance with examples as disclosed herein. In some examples, aspects of the operations of 1615 may be performed by a feedback mode selection component 1235 as described with reference to FIG. 12.

At 1620, the method may include receiving a feedback message corresponding to the one or more downlink messages via the first set of resources or the second set of resources according to the selected feedback mode. The operations of 1620 may be performed in accordance with examples as disclosed herein. In some examples, aspects of the operations of 1620 may be performed by a feedback message component 1240 as described with reference to FIG. 12.

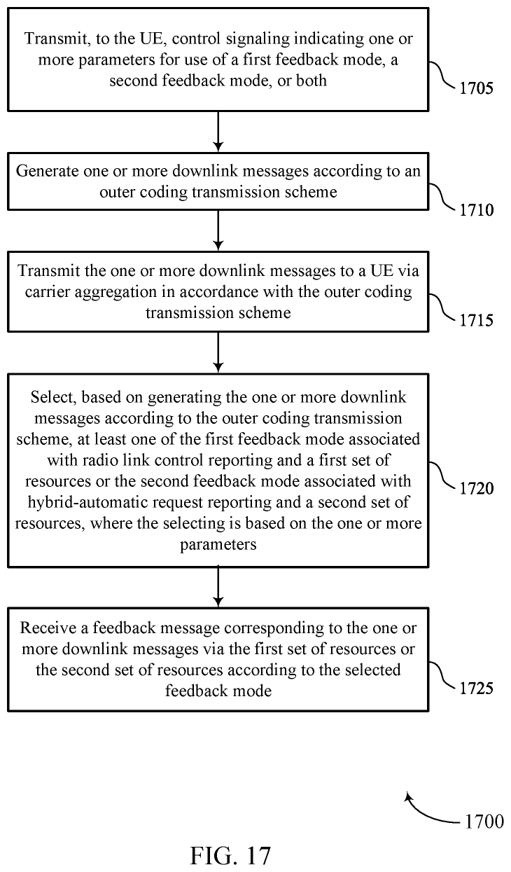

FIG. 17 illustrates a flowchart showing a method 1700 that supports feedback signaling in carrier aggregation and outer coding scenarios in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to the UE, control signaling indicating one or more parameters for use of a first feedback mode, a second feedback mode, or both. The operations of 1705 may be performed in accordance with examples as disclosed herein. In some examples, aspects of the operations of 1705 may be performed by a control signaling component 1245 as described with reference to FIG. 12.

At 1710, the method may include generating one or more downlink messages according to an outer coding transmission scheme. The operations of 1710 may be performed in accordance with examples as disclosed herein. In some examples, aspects of the operations of 1710 may be performed by a downlink message generation component 1225 as described with reference to FIG. 12.

At 1715, the method may include transmitting the one or more downlink messages to a UE via carrier aggregation in accordance with the outer coding transmission scheme. The operations of 1715 may be performed in accordance with examples as disclosed herein. In some examples, aspects of the operations of 1715 may be performed by a downlink message transmission component 1230 as described with reference to FIG. 12.

At 1720, the method may include selecting, based on generating the one or more downlink messages according to the outer coding transmission scheme, at least one of the first feedback mode associated with RLC reporting and a first set of resources or the second feedback mode associated with hybrid-automatic request reporting and a second set of resources, where the selecting is based on the one or more parameters. The operations of 1720 may be performed in accordance with examples as disclosed herein. In some examples, aspects of the operations of 1720 may be performed by a feedback mode selection component 1235 as described with reference to FIG. 12.

At 1725, the method may include receiving a feedback message corresponding to the one or more downlink messages via the first set of resources or the second set of resources according to the selected feedback mode. The operations of 1725 may be performed in accordance with examples as disclosed herein. In some examples, aspects of the operations of 1725 may be performed by a feedback message component 1240 as described with reference to FIG. 12.

The following provides an overview of aspects of the present disclosure:

Aspect 1: A method for wireless communications at a UE, comprising: receiving, via carrier aggregation, one or more downlink messages from a network entity in accordance with an outer coding transmission scheme; deactivating a retransmission protocol associated with the one or more downlink messages based at least in part on the outer coding transmission scheme being applied to the one or more downlink messages; selecting, based at least in part on the outer coding transmission scheme being applied to the one or more downlink messages, at least one of a first feedback mode associated with RLC reporting and a first set of resources or a second feedback mode associated with hybrid-automatic request reporting and a second set of resources; and transmitting a feedback message corresponding to the one or more downlink messages via the first set of resources or the second set of resources according to the selected feedback mode.

Aspect 2: The method of aspect 1, further comprising: receiving, from the network entity, control signaling indicating one or more parameters for use of the first feedback mode, the second feedback mode, or both, wherein the selecting is based at least in part on the one or more parameters.

Aspect 3: The method of any of aspects 1 through 2, further comprising: selecting the at least one of the first feedback mode or the second feedback mode based at least in part on one or more conditions being satisfied, wherein the one or more conditions are associated with a power status at the UE, a threshold latency corresponding to the one or more downlink messages, or a combination thereof.

Aspect 4: The method of any of aspects 1 through 3, wherein the selecting comprises: selecting a combination of the first feedback mode and the second feedback mode, wherein the first feedback mode corresponds to a first periodicity and the second feedback mode corresponds to a second periodicity, wherein the first periodicity is greater than the second periodicity.

Aspect 5: The method of aspect 4, wherein transmitting the feedback message comprises: transmitting a first feedback message via the first set of resources according to the first periodicity; and transmitting a second feedback message via the second set of resources according to the second periodicity.

Aspect 6: The method of aspect 5, wherein transmitting the feedback message comprises: activating a first resource of the second set of resources according to the second periodicity; and transmitting, via the activated first resource of the second set of resources, a block error report, an indication of a missed message via a physical downlink control channel, or a combination thereof.

Aspect 7: The method of any of aspects 5 through 6, wherein transmitting the first feedback message and the second feedback message comprises: alternating between transmitting via respective resources associated with the first set of resources and the second set of resources according to the first periodicity and the second periodicity.

Aspect 8: The method of any of aspects 1 through 7, wherein transmitting the feedback message comprises: transmitting a RLC status report via the first set of resources according to the first feedback mode based at least in part on detecting a missed RLC packet data unit, wherein a HARQ protocol associated with the second feedback mode is deactivated according to the selecting.

Aspect 9: The method of aspect 8, further comprising: allowing one or more timers to expire, or setting the one or more timers to zero, based at least in part on selecting the first feedback mode, wherein the one or more timers are associated with RLC status signaling.

Aspect 10: The method of any of aspects 8 through 9, further comprising: including, in the RLC status report, an indication of a quantity of segments associated with the outer coding transmission scheme that have been successfully received by the UE.

Aspect 11: The method of any of aspects 1 through 10, wherein transmitting the feedback message comprises: transmitting a plurality of feedback messages via the first set of resources of a primary component carrier for a first cell group and via the second set of resources of the primary component carrier for the first cell group, the plurality of feedback messages comprising the feedback message.

Aspect 12: The method of any of aspects 1 through 11, further comprising: generating the feedback message according to a HARQ codebook type, wherein transmitting the feedback message is based at least in part on the generating.

Aspect 13: The method of any of aspects 1 through 12, further comprising: entering a sleep mode based at least in part on transmitting the feedback message; and deactivating the carrier aggregation, the outer coding transmission scheme, or both, based at least in part on entering the sleep mode.

Aspect 14: The method of aspect 13, further comprising: refraining from transmitting one or more additional feedback messages via at least a portion of the first set of resources and the second set of resources associated with retransmissions of the one or more downlink messages based at least in part on entering the sleep mode during the portion of the first set of resources and the second set of resources, deactivating the retransmission protocol, or both.

Aspect 15: The method of any of aspects 13 through 14, further comprising: receiving, from the network entity based at least in part on transmitting the feedback message, an indication that no additional downlink messages are pending, wherein entering the sleep mode is based at least in part on receiving the indication.

Aspect 16: The method of any of aspects 13 through 15, further comprising: receiving, from the network entity, an indication of a threshold quantity of segments associated with the outer coding transmission scheme, wherein entering the sleep mode is based at least in part on the quantity of segments associated with the outer coding transmission scheme that have been successfully received by the UE satisfies the threshold quantity of segments.

Aspect 17: The method of any of aspects 1 through 16, further comprising: receiving, from the network entity, an indication of a periodicity associated with the first feedback mode, the second feedback mode, or a combination thereof, wherein transmitting the feedback message is based at least in part on the periodicity.

Aspect 18: The method of any of aspects 1 through 17, further comprising: receiving control signaling triggering aperiodic feedback signaling via the first set of resources or the second set of resources, wherein transmitting the feedback message is based at least in part on receiving the control signaling.

Aspect 19: The method of any of aspects 1 through 18, further comprising: receiving control signaling indicating a carrier aggregation mode, an instruction to deactivate RLC retransmissions, or a combination thereof.

Aspect 20: The method of any of aspects 1 through 19, wherein the outer coding transmission scheme comprises a PDCP distribution outer coding scheme associated with a threshold link quality.

Aspect 21: A method for wireless communications at a network entity, comprising: generating one or more downlink messages according to an outer coding transmission scheme; transmitting the one or more downlink messages to a UE via carrier aggregation in accordance with the outer coding transmission scheme; selecting, based at least in part on generating the one or more downlink messages according to the outer coding transmission scheme, at least one of a first feedback mode associated with RLC reporting and a first set of resources or a second feedback mode associated with hybrid-automatic request reporting and a second set of resources; and receiving a feedback message corresponding to the one or more downlink messages via the first set of resources or the second set of resources according to the selected feedback mode.

Aspect 22: The method of aspect 21, further comprising: transmitting, to the UE, control signaling indicating one or more parameters for use of the first feedback mode, the second feedback mode, or both, wherein the selecting is based at least in part on the one or more parameters.

Aspect 23: The method of any of aspects 21 through 22, further comprising: selecting the at least one of the first feedback mode and the second feedback mode based at least in part on one or more conditions being satisfied, wherein the one or more conditions are associated with a power status at the UE, a threshold latency corresponding to the one or more downlink messages, or a combination thereof.

Aspect 24: The method of any of aspects 21 through 23, wherein the selecting comprises: selecting a combination of the first feedback mode and the second feedback mode, wherein the first feedback mode corresponds to a first periodicity and the second feedback mode corresponds to a second periodicity, wherein the first periodicity is greater than the second periodicity.

Aspect 25: The method of aspect 24, wherein receiving the feedback message comprises: receiving a first feedback message via the first set of resources according to the first periodicity; and receiving a second feedback message via the second set of resources according to the second periodicity.

Aspect 26: The method of any of aspects 24 through 25, wherein receiving the first feedback message and the second feedback message comprises: alternating between receiving via respective resources associated with the first set of resources and the second set of resources according to the first periodicity and the second periodicity.

Aspect 27: The method of any of aspects 21 through 26, wherein receiving the feedback message comprises: receiving a RLC status report via the first set of resources according to the first feedback mode indicating a missed RLC packet data unit, wherein a HARQ protocol associated with the second feedback mode is deactivated according to the selecting.

Aspect 28: The method of aspect 27, further comprising: receiving, in the RLC status report, an indication of a quantity of segments associated with the outer coding transmission scheme that have been successfully received by the UE.

Aspect 29: The method of aspect 28, further comprising: transmitting, to the UE, an indication of a threshold quantity of segments associated with the outer coding transmission scheme; and refraining from transmitting one or more additional segments associated with the outer coding transmission scheme based at least in part on the quantity of segments associated with the outer coding transmission scheme satisfying the threshold quantity of segments.

Aspect 30: The method of any of aspects 21 through 29, wherein receiving the feedback message comprises: receiving a plurality of feedback messages via the first set of resources of a primary component carrier for a first cell group and via the second set of resources of the primary component carrier for the first cell group, the plurality of feedback messages comprising the feedback message.

Aspect 31: The method of any of aspects 21 through 30, wherein receiving the feedback message comprises: receiving the feedback message according to a HARQ codebook type.

Aspect 32: The method of any of aspects 21 through 31, further comprising: refraining from transmitting one or more additional downlink messages based at least in part on receiving the feedback message; and refraining from monitoring for one or more additional feedback messages during at least a portion of the first set of resources, the second set of resources, or both.

Aspect 33: The method of aspect 32, further comprising: deactivating a retransmission protocol associated with the one or more downlink messages, wherein refraining from transmitting the one or more additional downlink messages is based at least in part on the deactivating.

Aspect 34: The method of any of aspects 32 through 33, further comprising: transmitting, to the UE, an indication that the one or more additional downlink messages are not pending, wherein refraining from transmitting the one or more additional downlink messages is based at least in part on receiving the indication.

Aspect 35: The method of any of aspects 21 through 34, further comprising: transmitting, to the UE, an indication of a periodicity associated with the first feedback mode, the second feedback mode, or a combination thereof, wherein receiving the feedback message is based at least in part on the periodicity.

Aspect 36: The method of any of aspects 21 through 35, further comprising: transmitting control signaling triggering aperiodic feedback signaling via the first set of resources or the second set of resources, wherein receiving the feedback message is based at least in part on receiving the control signaling.

Aspect 37: The method of any of aspects 21 through 36, further comprising: transmitting control signaling indicating a carrier aggregation mode, an instruction to deactivate RLC retransmissions, or a combination thereof.

Aspect 38: The method of any of aspects 21 through 37, wherein the outer coding transmission scheme comprises a PDCP distribution outer coding scheme associated with a threshold link quality.

Aspect 39: An apparatus for wireless communications at a UE, comprising a processor; memory coupled with the processor; and instructions stored in the memory and executable by the processor to cause the apparatus to perform a method of any of aspects 1 through 20.

Aspect 40: An apparatus for wireless communications at a UE, comprising at least one means for performing a method of any of aspects 1 through 20.

Aspect 41: A non-transitory computer-readable medium storing code for wireless communications at a UE, the code comprising instructions executable by a processor to perform a method of any of aspects 1 through 20.

Aspect 42: An apparatus for wireless communications at a network entity, comprising a processor; memory coupled with the processor; and instructions stored in the memory and executable by the processor to cause the apparatus to perform a method of any of aspects 21 through 38.

Aspect 43: An apparatus for wireless communications at a network entity, comprising at least one means for performing a method of any of aspects 21 through 38.

Aspect 44: A non-transitory computer-readable medium storing code for wireless communications at a network entity, the code comprising instructions executable by a processor to perform a method of any of aspects 21 through 38.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An user equipment (UE), comprising:
a processor;
memory coupled with the processor; and
instructions stored in the memory and executable by the processor to cause the UE to:
receive, via carrier aggregation, one or more downlink messages from a network entity in accordance with an outer coding transmission scheme;
deactivate a retransmission protocol associated with the one or more downlink messages based at least in part on application of the outer coding transmission scheme to the one or more downlink messages;
select, based at least in part on application of the outer coding transmission scheme to the one or more downlink messages, at least one of a first feedback mode associated with radio link control reporting and a first set of resources or a second feedback mode associated with hybrid-automatic request reporting and a second set of resources; and
transmit a feedback message corresponding to the one or more downlink messages via the first set of resources or the second set of resources according to the selected feedback mode.

2. The UE of claim 1, wherein the instructions are further executable by the processor to cause the UE to:
receive, from the network entity, control signaling indicating one or more parameters for use of the first feedback mode, the second feedback mode, or both, wherein selection of the at least one of the first feedback mode or the second feedback mode is based at least in part on the one or more parameters.

3. The UE of claim 1, wherein the instructions are further executable by the processor to cause the UE to:
select the at least one of the first feedback mode or the second feedback mode based at least in part on one or more conditions being satisfied, wherein the one or more conditions are associated with a power status at the UE, a threshold latency corresponding to the one or more downlink messages, or a combination thereof.

4. The UE of claim 1, wherein the instructions to select are executable by the processor to cause the UE to:
select a combination of the first feedback mode and the second feedback mode, wherein the first feedback mode corresponds to a first periodicity and the second feedback mode corresponds to a second periodicity, wherein the first periodicity is greater than the second periodicity.

5. The UE of claim 4, wherein the instructions to transmit the feedback message are executable by the processor to cause the UE to:
transmit a first feedback message via the first set of resources according to the first periodicity; and
transmit a second feedback message via the second set of resources according to the second periodicity.

6. The UE of claim 5, wherein the instructions to transmit the feedback message are executable by the processor to cause the UE to:
activate a first resource of the second set of resources according to the second periodicity; and
transmit, via the activated first resource of the second set of resources, a block error report, an indication of a missed message via a physical downlink control channel, or a combination thereof.

7. The UE of claim 5, wherein the instructions to transmit the first feedback message and the second feedback message are executable by the processor to cause the UE to:
alternate between transmission via respective resources associated with the first set of resources and the second set of resources according to the first periodicity and the second periodicity.

8. The UE of claim 1, wherein the instructions to transmit the feedback message are executable by the processor to cause the UE to:
transmit a radio link control status report via the first set of resources according to the first feedback mode based at least in part on detection of a missed radio link control packet data unit, wherein a hybrid automatic repeat request protocol associated with the second feedback mode is deactivated according to selection of the at least one of the first feedback mode or the second feedback mode.

9. The UE of claim 8, wherein the instructions are further executable by the processor to cause the UE to:
allow one or more timers to expire, or set the one or more timers to zero, based at least in part on selection of the first feedback mode, wherein the one or more timers are associated with radio link control status signaling.

10. The UE of claim 8, wherein the instructions are further executable by the processor to cause the UE to:
include, in the radio link control status report, an indication of a quantity of segments associated with the outer coding transmission scheme that have been successfully received by the UE.

11. The UE of claim 1, wherein the instructions to transmit the feedback message are executable by the processor to cause the UE to:
transmit a plurality of feedback messages via the first set of resources of a primary component carrier for a first cell group and via the second set of resources of the primary component carrier for the first cell group, the plurality of feedback messages comprising the feedback message.

12. The UE of claim 1, wherein the instructions are further executable by the processor to cause the UE to:
generate the feedback message according to a hybrid automatic repeat request codebook type, wherein transmission of the feedback message is based at least in part on generation of the feedback message.

13. The UE of claim 1, wherein the instructions are further executable by the processor to cause the UE to:
enter a sleep mode based at least in part on transmission of the feedback message; and
deactivate the carrier aggregation, the outer coding transmission scheme, or both, based at least in part on the sleep mode being entered.

14. The UE of claim 13, wherein the instructions are further executable by the processor to cause the UE to:
refrain from transmission of one or more additional feedback messages via at least a portion of the first set of resources and the second set of resources associated with retransmissions of the one or more downlink messages based at least in part on the sleep mode being entered during the portion of the first set of resources and the second set of resources, deactivation of the retransmission protocol, or both.

15. The UE of claim 13, wherein the instructions are further executable by the processor to cause the UE to:
receive, from the network entity based at least in part on transmission of the feedback message, an indication that no additional downlink messages are pending, wherein the sleep mode is entered based at least in part on reception of the indication.

16. The UE of claim 13, wherein the instructions are further executable by the processor to cause the UE to:
receive, from the network entity, an indication of a threshold quantity of segments associated with the outer coding transmission scheme, wherein the sleep mode is entered based at least in part on the quantity of segments associated with the outer coding transmission scheme that have been successfully received by the UE satisfies the threshold quantity of segments.

17. The UE of claim 1, wherein the instructions are further executable by the processor to cause the UE to:
receive, from the network entity, an indication of a periodicity associated with the first feedback mode, the second feedback mode, or a combination thereof, wherein transmission of the feedback message is based at least in part on the periodicity.

18. The UE of claim 1, wherein the instructions are further executable by the processor to cause the UE to:
receive control signaling that triggers aperiodic feedback signaling via the first set of resources or the second set of resources, wherein transmission of the feedback message is based at least in part on reception of the control signaling.

19. The UE of claim 1, wherein the instructions are further executable by the processor to cause the UE to:
receive control signaling that indicates a carrier aggregation mode, an instruction to deactivate radio link control retransmissions, or a combination thereof.

20. The UE of claim 1, wherein the outer coding transmission scheme comprises a packet data convergence protocol distribution outer coding scheme associated with a threshold link quality.

21. An network entity, comprising:
a processor;
memory coupled with the processor; and
instructions stored in the memory and executable by the processor to cause the network entity to:
generate one or more downlink messages according to an outer coding transmission scheme;
transmit the one or more downlink messages to a user equipment (UE) via carrier aggregation in accordance with the outer coding transmission scheme;
select, based at least in part on generation of the one or more downlink messages according to the outer coding transmission scheme, at least one of a first feedback mode associated with radio link control reporting and a first set of resources or a second feedback mode associated with hybrid-automatic request reporting and a second set of resources; and
receive a feedback message corresponding to the one or more downlink messages via the first set of resources or the second set of resources according to the selected feedback mode.

22. The network entity of claim 21, wherein the instructions are further executable by the processor to cause the network entity to:
transmit, to the UE, control signaling that indicates one or more parameters for use of the first feedback mode, the second feedback mode, or both, wherein selection of the at least one of the first feedback mode or the second feedback mode is based at least in part on the one or more parameters.

23. The network entity of claim 21, wherein the instructions are further executable by the processor to cause the network entity to:
select the at least one of the first feedback mode and the second feedback mode based at least in part on satisfaction of one or more conditions, wherein the one or more conditions are associated with a power status at the UE, a threshold latency corresponding to the one or more downlink messages, or a combination thereof.

24. The network entity of claim 21, wherein the instructions to select are executable by the processor to cause the network entity to:
select a combination of the first feedback mode and the second feedback mode, wherein the first feedback mode corresponds to a first periodicity and the second feedback mode corresponds to a second periodicity, wherein the first periodicity is greater than the second periodicity.

25. The network entity of claim 21, wherein the instructions to receive the feedback message are executable by the processor to cause the network entity to:
receive a radio link control status report via the first set of resources according to the first feedback mode that indicates a missed radio link control packet data unit, wherein a hybrid automatic repeat request protocol associated with the second feedback mode is deactivated according to selection of the at least one of the first feedback mode or the second feedback mode.

26. The network entity of claim 21, wherein the instructions to receive the feedback message are executable by the processor to cause the network entity to:
receive a plurality of feedback messages via the first set of resources of a primary component carrier for a first cell group and via the second set of resources of the primary component carrier for the first cell group, the plurality of feedback messages comprising the feedback message.

27. The network entity of claim 21, wherein the instructions to receive the feedback message are executable by the processor to cause the network entity to:
receive the feedback message according to a hybrid automatic repeat request codebook type.

28. The network entity of claim 21, wherein the instructions are further executable by the processor to cause the network entity to:
refrain from transmission of one or more additional downlink messages based at least in part on receipt of the feedback message; and
refrain from monitoring for one or more additional feedback messages during at least a portion of the first set of resources, the second set of resources, or both.

29. A method for wireless communications at a user equipment (UE), comprising:
receiving, via carrier aggregation, one or more downlink messages from a network entity in accordance with an outer coding transmission scheme;
deactivating a retransmission protocol associated with the one or more downlink messages based at least in part on the outer coding transmission scheme being applied to the one or more downlink messages;
selecting, based at least in part on the outer coding transmission scheme being applied to the one or more downlink messages, at least one of a first feedback mode associated with radio link control reporting and a first set of resources or a second feedback mode associated with hybrid-automatic request reporting and a second set of resources; and
transmitting a feedback message corresponding to the one or more downlink messages via the first set of resources or the second set of resources according to the selected feedback mode.

30. A method for wireless communications at a network entity, comprising:
generating one or more downlink messages according to an outer coding transmission scheme;
transmitting the one or more downlink messages to a user equipment (UE) via carrier aggregation in accordance with the outer coding transmission scheme;
selecting, based at least in part on generating the one or more downlink messages according to the outer coding transmission scheme, at least one of a first feedback mode associated with radio link control reporting and a first set of resources or a second feedback mode associated with hybrid-automatic request reporting and a second set of resources; and
receiving a feedback message corresponding to the one or more downlink messages via the first set of resources or the second set of resources according to the selected feedback mode.
